(19) United States
(12) Patent Application Publication
(10) Pub. No.: US 2011/0137833 A1
(43) Pub. Date: Jun. 9, 2011

(54) DATA PROCESSING APPARATUS, DATA PROCESSING METHOD AND PROGRAM

(76) Inventors: Naoki IDE, Tokyo (JP); Masato Ito, Tokyo (JP); Kohtaro Sabe, Tokyo (JP)

(21) Appl. No.: 12/954,194

(22) Filed: Nov. 24, 2010

(30) Foreign Application Priority Data
Dec. 4, 2009 (JP) P2009-276999

(51) Int. Cl. G06N 5/02; G06F 15/18

(52) U.S. Cl. 706/12; 706/52; 706/46

(57) ABSTRACT

The data processing apparatus includes a state series generation unit and a computing unit. The state series generation unit generates a time series data of state nodes from a time series data of event. The state transition model of the event is expressed as a stochastic state transition model. The computing unit computes the parameters for the stochastic state transition model of events by computing parameters of time series data corresponding to an appearance frequency of the state nodes, the appearance frequency of transitions among the state nodes and the like.

### BACKGROUND OF THE INVENTION

1. Field of the Invention

The present invention relates to a data processing apparatus, a data processing method, and a program, especially, to more simply learn the learning parameters to predict the probability, course, and elapsed time at the specific location or the place where a specific action is conducted in the near future of the current time or later.

2. Description of the Related Art

Recently, there is active research where a user's state is learned by modeling with time series data obtained from wearable sensors that a user is wearing, and the present state of the users is recognized by using a model obtained from learning (for example, see Japanese patent Application Publication Laid-open No. 2006-134080, Japanese patent Application Publication Laid-open No. 2008-204040, and “Life Patterns: structure from wearable sensors”, Brian Patrick Clarkson, Doctoral Thesis, MIT, 2002.

The inventor firstly proposed as Japanese Patent Application No. 2009-180780 the method that estimates stochastically a plurality of possibilities of the user's action state at the desired time in the future. In the method of the Japanese Patent Application No. 2009-180780, the user's action state from time series data is learned as a stochastic state transition model, and by using a learned stochastic state transition model, it may be possible to recognize the present action state and to stochastically estimate the user's action state of so-called “after predetermined time”. Then, as an example of an estimation of the user's action state after “a predetermined time”, an example is suggested to estimate the user's destination (location) after a predetermined time by recognizing the user's present location.

Furthermore, the inventor further improved the Japanese Patent Application No. 2009-180780, and proposed as Japanese Patent Application No. 2009-208064 the method to estimate the arrival probability, course, and time to a plurality of destinations is estimated even when the elapsed time from the present time of so called “after predetermined time” is not specified. In the method of Japanese Patent Application No. 2009-208064, it may be possible to automatically detect a destination candidate by finding a location corresponding to a node of the destination from among the nodes in the probability model.

### SUMMARY OF THE INVENTION

In the methods of the Japanese Patent Application No. 2009-180780 and Japanese Patent Application No. 2009-208064, the hidden Markov model is adopted as a example of the stochastic state transition model that expresses the action state of a user. Then, in the method of Japanese Patent Application No. 2009-208064, a two-step process that the output results obtained by the first hidden Markov model is input to the second hidden Markov model to be a subsequent step is adopted for a learning instrument of the hidden Markov model that expresses the action state of the user. For the two-step process, the learning time took twice as long, and process load was large.

It is desirable to more simply learn the learning parameters to predict the probability, course, and elapsed time at the specific location or the place where a specific action is conducted in the near future of the present time or later.

A data processing apparatus according to an embodiment of the present invention, includes: state series generation means that generates a time series data of state nodes from a time series data of a first event between a time series data of a first event and a second event when a state transition model of the first event is expressed as a stochastic state transition model; and computing means that computes the parameters for the stochastic state transition model of the first event and the second event by computing parameters of the time series data that corresponds to an appearance frequency of the state nodes, an appearance frequency of transitions among the state nodes, and the state nodes using the time series data of the first event and time series data of the state nodes.

According to another embodiment of the present invention, there is provided a data processing method using a data processing apparatus that outputs parameters of a stochastic state transition model of a first event and a second event by including state series generation means and computing means, the method including: causing the state series generation means of the data processing apparatus to generate the time series data of the state nodes when expresses the state transition model of the first event as the stochastic state transition model from the time series data of the second event between time series data of the first event and the second event; and causing the computing means to compute parameter of the stochastic state transition model of the first event and second event by computing parameters of the time series data that corresponds to the appearance frequency of the state nodes, the appearance frequency of transitions among the state nodes, and the state nodes by using the time series data of the first event and the time series data of the state nodes.

According to further another embodiment of the present invention, there is provided a program causing a computer to function including: the state series generation means generates the time series data of state nodes from the time series data of the first event between the time series data of the first event and the second event when a state transition model of the first event is expressed as the stochastic state transition model; and the computing means computes parameters of the stochastic state transition model of the first event and second event by computing parameters of the time series data that corresponds to the appearance frequency of the state nodes, the appearance frequency of transitions among the state nodes, and the state nodes by using the time series data of the first event and the time series data of the state nodes.

In the embodiments of the invention, the time series data of state nodes are generated from the time series data of the first event between the time series data of the first event and the second event when a state transition model of the first event is expressed as the stochastic state transition model, and parameters of the stochastic state transition model of the first event and second event are computed by computing parameters of the time series data that corresponds to the appearance frequency of the state nodes, the appearance frequency of transitions among the state nodes, and the state nodes by using the time series data of the first event and the time series data of the state nodes.

The data processing apparatus may be an independent apparatus or an inter block that make up one apparatus.

According to the embodiments of the invention, learning parameters can be more easily learned to predict the probability, course, and elapsed time at the specific location or the place where a specific action is conducted in the near future of the present time or later.

### BRIEF DESCRIPTION OF THE DRAWINGS

FIG. 1 is a block diagram showing an example of configuration of the prediction system for Japanese Patent Application No. 2009-208064.

FIG. 2 is a block diagram showing an example of hardware configuration of the prediction system.

FIG. 3 is a graph showing the time series data that is input to prediction system.

FIG. 4 is a diagram showing an example of HMM

FIG. 5 is a diagram showing an example of HMM used in voice recognition.

FIGS. 6A and 6B are diagrams showing an example of HMM given the sparse restrictions.

FIG. 7 is a diagram showing a simple example of course discovery process by action prediction section.

FIG. 8 is a diagram showing an example of the configuration in which the action learning section of the FIG. 1 can be adopted.

FIG. 9 is a diagram describing the action mode to identify predictive system.

FIG. 10 is a flowchart of arrival time prediction processing.

FIG. 11 is a flowchart of arrival time prediction processing.

FIG. 12 is a block diagram showing a configuration example of action learning section for a prediction system that the invention is applied.

FIG. 13 is a flowchart a learning processing.

FIG. 14 is a diagram describing the loop corrective process by the state series correction unit.

FIG. 15 is a flowchart of the loop corrective process by the state series correction unit.

FIG. 16 is a diagram describing the sharing node corrective process by the state series correction unit.

FIG. 17 is a flowchart of the sharing node corrective process by the state series correction unit.

FIG. 18 is a diagram describing the other shared node corrective process.

FIG. 19 is a diagram describing the effect of adopting an action learning section shown in FIG. 12.

FIG. 20 is a diagram describing the effect of adopting an action learning section shown in FIG. 12.

FIG. 21 is a diagram describing the effect of adopting an action learning section shown in FIG. 12.

FIG. 22 is a diagram describing the effect of adopting the state series correction unit.

FIG. 23 is a diagram describing the effect of adopting the state series correction unit.

FIG. 24 is a diagram describing the effect of adopting the state series correction unit.

FIG. 25 is a block diagram showing a configuration example of an embodiment form for computer applied the invention.

### DESCRIPTION OF THE PREFERRED EMBODIMENTS

The form to implement the invention (hereinafter, the embodiment) is described in the following.

For comparing to the related arts described in “BACKGROUND OF THE INVENTION”, the method suggested in Japanese Patent Application No. 2009-208064 is described briefly, and then the embodiment applied to the invention is described. That is, description is done in the following order.

1. An embodiment of Japanese Patent Application No. 2009-208064

2. An embodiment of the invention (the embodiment where learning parameters are more easily obtained than in the embodiment of Japanese Patent Application No. 2009-208064)

### 1. An Embodiment of Japanese Patent Application No. 2009-208064

### [A Configuration Example of Prediction Processing System for Japanese Patent Application No. 2009-208064]

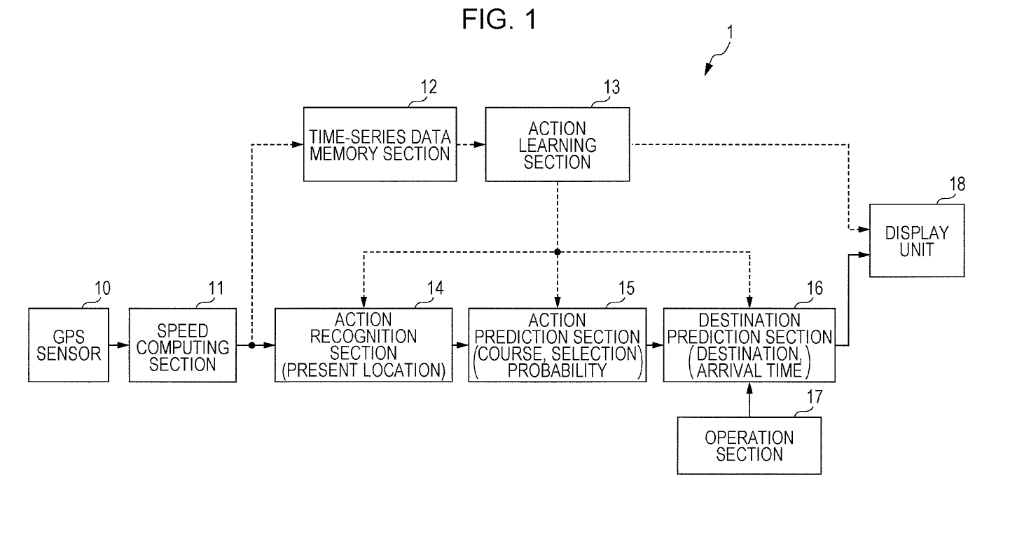

FIG. 1 is a block diagram showing an example of configuration of the prediction system for Japanese Patent Application No. 2009-208064.

The prediction system 1 is configured to have a GPS sensor 10, a speed computing section 11, a time series data memory section 12, an action learning section 13, an action recognition section 14, an action prediction section 15, a destination prediction section 16, an operation section 17, and a display section 18.

The prediction system 1 conducts the learning processing to learn as the stochastic state transition model the user's action state (state which is expressed action and activity patterns) from time series data indicating the present location which is obtained by the GPS sensor 10.

Also, the prediction system 1 conducts the prediction process to predict the arrival probability, course, and the arrival time for reaching to the destinations after predicting the user's destinations by using the stochastic state transition model (user activity model) that is represented by the parameters obtained through the learning processing. In addition, the destinations may be predicted as multiple destinations as well as a single destination.

In the destinations such as home, office, station, shopping destination, and restaurant or the like, the user generally stays for the predetermined time, and the movement speed of the user is substantially zero. On the other hand, for the case when the user moves toward a destination, the movement speed of the user would be a state which changes with specific patterns depending on means of transportation. Therefore, it is possible to predict the place of the stationary state as the destinations by recognizing the user's action state, that is, whether the user is stationary at a destination (the stationary state) or is moving (the movement state), from the information of user's movement speed.

In FIG. 1, the dotted arrow shows the flow of data in the learning processing and the solid arrow shows the flow of data in the predicting process.

The GPS sensor 10 sequentially acquires in regular time intervals (for example, 15 sec intervals) latitude and longitude data indicating its own location. Additionally, the GPS sensor 10 may not be able to acquire location data at regular time intervals. For example, it may be difficult to search for the satellites for example when the user is in a tunnel or underground, and the acquiring interval becomes long. In this case, it is possible to compensate for the data by conducting interpolation process or the like.

In the learning processing, the GPS sensor 10 supplies to the speed computing section 11 the obtained latitude and longitude location data and the acquiring time when the data was acquired. In prediction processing, the GPS sensor 10 supplies to the speed computing section 11 the acquired location data.

The speed computing section 11 computes movement speed from the location data which is supplied by the GPS sensor 10.

Specifically, the location data obtained at k^{th} steps (k^{th})) at constant time intervals is expressed by time tₖ, longitude yₖ and latitude xₖ, and the movement speed vxₖ of k^{th} steps in the x direction and the movement speed vyₖ of k^{th} steps in the y direction can be calculated by the following equation (1).

$${vx}_{k} = \frac{{x}_{k} - {x}_{k - 1}}{{t}_{k} - {t}_{k - 1}} {vy}_{k} = \frac{{y}_{k} - {y}_{k - 1}}{{t}_{k} - {t}_{k - 1}} \qquad ( 1 )$$

In equation (1), the latitude and longitude data obtained from the GPS sensor 10 is used. However, the processing such as converting the latitude and longitude data into distance or speed per hour or speed per minute which represents the speed may be appropriately conducted if when necessary.

The speed computing section 11 additionally obtains computing movement speed vₖ and a variation in movement direction θₖ at k^{th} step expressed in equation (2) from the movement speed vxₖ and vyₖ obtained from equation (1).

$${v}_{k} = \sqrt{{vx}_{k}^{2} + {vy}_{k}^{2}} {θ}_{k} = {sin}^{- 1} ( \frac{{vx}_{k} \cdot {vy}_{k - 1} - {vx}_{k - 1} \cdot {vy}_{k}}{{v}_{k} \cdot {v}_{k - 1}} ) \qquad ( 2 )$$

The method of using the movement speed vₖ and a variation on movement direction θₖ at k^{th} step expressed in equation (2) is a better way to retrieve the features of movement than movement speeds vxₖ and vyₖ for the following reasons.

1. Since there is bias in the distribution of data of movement speed vxₖ and vyₖ in the latitude or longitude axis, there may be a possibility that identification is difficult to perform in the case of different angles even if the same moving means (such as train or on foot) is used. However, by using movement speed vₖ such a possibility is low.

2. For the case of learning only by the absolute magnitude of movement speed (|v|), walking and stationary are difficult to be identified because of |v| that occurs by noise in the apparatus. It is possible to reduce the effect of noise by taking into consideration the variation in movement direction also.

3. The variation in movement direction is small during movement, but since the movement direction is not defined while stationary, it is easy to identify the movement and stationary states by using the variation in movement direction.

For the above reason, the speed computing section 11 supplies to the time series data memory section 12 or the action recognition section 14 with location data after seeking the movement speed vₖ and the variation in movement direction θₖ expressed by equation (2) as movement speed data.

Also, the speed computing section 11 conducts a filtering process (pre-treatment) by using movement average to remove noise component before computing the movement speed vₖ and the variation in movement direction θₖ.

Furthermore, the variation in movement direction θₖ is abbreviated as movement direction θₖ in the following.

The GPS sensor 10 contains an element that can output the movement speed also. For the case where the GPS sensor 10 is employed, it is possible to skip the speed computing section 11 and to use the movement speed that the GPS sensor 10 outputs just as it is.

The time series data memory section 12 stores the location data and the movement speed, that is, the time series data of the location data and the movement speed which are supplied in time series from the speed computing section 11. Because of learning of action and activity patterns of the user, time series data accumulated for a period of time of about several days may be necessary.

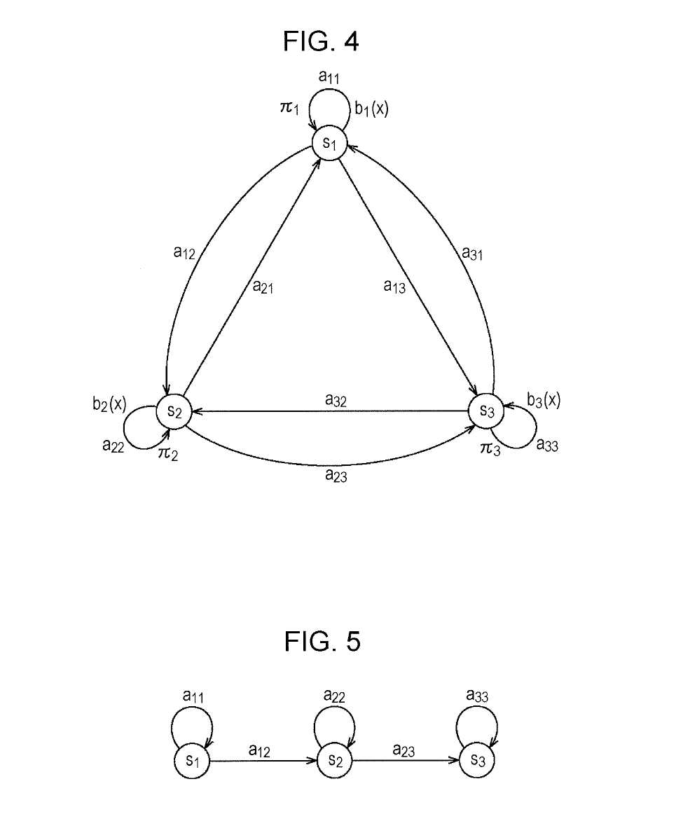

The action learning section 13 learns the action status of the user who carries the equipment with the built-in GPS sensor 10 based on the time series data stored at the time series data memory section 12 as the stochastic state transition model. Since the time series data is the data indicating the location and movement speed of the user, the user's action status learned as the stochastic state transition model becomes a movement locus and action state of the user. The stochastic state transition model, which contains the hidden state, for example, such as Ergodic HMM (Hidden Markov Model) or the like, can be adopted as the stochastic state transition model used for learning. In the prediction system 1, a model where sparse restrictions are given in Ergodic HMM is adopted as the stochastic state transition model. In addition, the calculation method of the parameter of Ergodic HMM and Ergodic HMM where the sparse restrictions have been given will be described later with reference from FIGS. 4 to 6.

The action learning section 13 supplies and displays on the display section 18 the data in which a learning result is shown. Moreover, the action learning section 13 supplies the parameter of the stochastic state transition model obtained by learning processing to the action recognition section 14, the action prediction section 15, and the destination prediction section 16.

The action recognition section 14 recognizes the user's present action state, i.e., a user's present location, using the stochastic state transition model of the parameter obtained by learning from the time series data of the location and movement speed supplied in real time from the speed computing section 11. The action recognition section 14 supplies the node number of a user's present state node to the action prediction section 15.

The action prediction section 15 searches (predicts) neither more nor less for the course which a user can take using the stochastic state transition model of the parameter obtained by learning from the present location of the user which is indicated by the node number of the state node supplied from the action recognition section 14. Moreover, the action prediction section 15 predicts the selection probability which is the probability that the course for which was searched for is chosen by calculating the occurrence probability for every course which was searched for.

The course which a user can take and its selection probability are supplied to the destination prediction section 16 from the action prediction section 15. Moreover, the information which the user input is supplied to the destination prediction section 16 from the operation section 17 when it may be necessary.

The destination prediction section 16 predicts a user's destination using the stochastic state transition model of the parameter obtained by learning.

Specifically, the destination prediction section 16 first enumerates destination candidates. The destination prediction section 16 makes a destination candidate the place where a recognized user's action state is in a stationary state.

Next, the destination prediction section 16 determines the destination candidate on the course which the user for whom the action prediction section 15 searched among the enumerated destination candidates can take as the destination, and predicts the arrival time to the destination for every course.

Next, the destination prediction section 16 computes the arrival probability for every determined destination. The destination prediction section 16 computes the sum of the selection probability of two or more of the courses as arrival probability of the destination when two or more courses exist in regard to the destination. When the number of the courses to the destination is only one, the selection probability of the course becomes the arrival probability of the destination as it is.

The destination prediction section 16 calculates the arrival time of the course to the predicted destination, and displays it on the display section 18.

The number of courses including the destination is a plurality. When it is hard to see for the case where all courses are displayed or when the number of courses is set as the predetermined number, it is necessary to determine the courses (hereinafter, called appropriately a displayed course also) displayed on the display section 18 out of all the courses including the destination. In such a case, in the action prediction section 15, since selection probability is computed in regard to each course, the destination prediction section 16 can determine the predetermined numbers of courses in order of high selection probability as display courses.

Moreover, when many courses to the destination exist, it is also possible to determine a display course in order of the shortest arrival time or the shortest distance to the destination besides determining a display course in the high order of a possibility of being chosen. In determining a display course in the order of shortest arrival time, first, the destination prediction section 16 calculates arrival time in regard to all the courses to the destination, and determines a display course based on the calculated arrival time, for example. First, in determining a display course in the order of shortest distance to the destination, in regard to all the courses to the destination, the destination prediction section 16 calculates the distance to the destination based on the information on the latitude and longitude corresponding to a state node, and determines a display course based on the calculated distance, for example.

Furthermore, in the similar way for the destination, the destination for a display object can be narrowed down so that only the predetermined number of destinations with a high arrival probability and the destination beyond a predetermined value of arrival probability may be displayed. In addition, the number of the destinations and courses displayed may differ.

The operation section 17 receives the predetermined information (for example, selection directions of a display course etc.), that the user input, and supplies it to the destination prediction section 16. The display section 18 displays the information supplied from the action learning section 13 or the destination prediction section 16.

### [An Example of Hardware Configuration of the Prediction System]

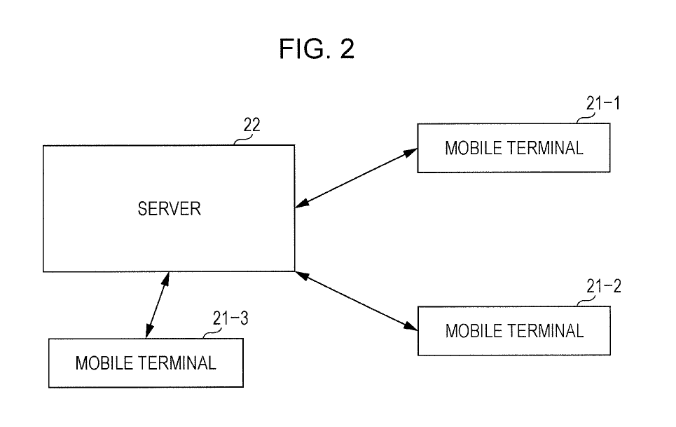

The hardware configuration shown in FIG. 2 can be used for the prediction system 1 constituted as mentioned above, for example. That is, FIG. 2 is a block diagram showing an example of hardware configuration of the prediction system 1.

The prediction system 1 is constituted by three sets of the mobile terminals from 21-1 to 21-3 and a server 22 in FIG. 2. Although mobile terminals from 21-1 to 21-3 are the mobile terminal 21 of the same type which has the same function, the users who own the mobile terminals from 21-1 to 21-3 are different. Therefore, in FIG. 2, although only three sets of the mobile terminals from 21-1 to 21-3 are shown, the mobile terminal 21 of the number according to the number of users can exist in practice.

The mobile terminal 21 can perform transfer of data with the server 22 by communication through networks, such as wireless communications and the Internet. The server 22 receives the data transmitted from the mobile terminal 21, and performs predetermined processing to the received data. Then, the server 22 transmits the processing result of data processing to the mobile terminal 21 by wireless communications etc.

Therefore, the mobile terminal 21 and the server 22 have at least the communications unit which performs communication by radio or cable.

Furthermore, the mobile terminal 21 may be equipped with the GPS sensor 10, the speed computing section 11, the operation section 17, and the display section 18 of FIG. 1. The server 22 can adopt a configuration where it is equipped with the time series data memory section 12, the action learning section 13, the action recognition section 14, the action prediction section 15, and the destination prediction section 16 of FIG. 1.

When this configuration is adopted, in learning processing, the mobile terminal 21 transmits the time series data acquired by the GPS sensor 10 and the speed computing section 11. The server 22 learns a user's action state by a stochastic state transition model based on the received time series data for learning. Then, in prediction processing, the mobile terminal 21 transmits the location data acquired by real time by the GPS sensor 10 and the speed computing section 11. Using the parameter obtained by learning, the server 22 recognizes the user's present action state, i.e., a user's present location, and further transmits the destination and the course and time to get there to the mobile terminal 21 as a processing result. The mobile terminal 21 displays the processing result transmitted from the server 22 on the display section 18.

Moreover, for example, the mobile terminal 21 may be equipped with the GPS sensor 10, the speed computing section 11, the action recognition section 14, the action prediction section 15, the destination prediction section 16, the operation section 17, and the display section 18 of FIG. 1. The server 22 can adopt a configuration where it is equipped with the time series data memory section 12 and the action learning section 13 of FIG. 1.

When this configuration is adopted, in learning processing, the mobile terminal 21 transmits the time series data acquired by the GPS sensor 10 and the speed computing section 11. Based on the received time series data for learning, the server 22 learns a user's action state by a stochastic state transition model, and transmits the parameter obtained by learning to the mobile terminal 21. Then, in prediction processing, using the parameter received from the server 22 and the location data acquired by real time by the GPS sensor 10 and the speed computing section 11, the mobile terminal 21 recognizes a user's present location, and further calculates the course and time to the destination. Then, the mobile terminal 21 displays the destination and the course and time to the destination as a computing result on the display section 18.

The role assignment between above mobile terminals 21 and servers 22 can be determined according to the throughput and communication environment of each data processing device.

For learning processing, although the time for each processing is very long, it is not necessary to process so frequently. Therefore, since the throughput of the server 22, rather than the mobile terminal 21 which can be carried, is high generally, the server 22 can perform learning processing (renewal of a parameter) based on the time series data accumulated about once on a day.

On the other hand, since it is desirable for prediction processing to be processed quickly and to be displayed corresponding to the location data updated by real time and at every moment, it is more desirable to process at the mobile terminal 21. If communication environment is rich, it is desirable that the server 22 performs prediction processing as mentioned above and only the prediction result is received from the server 22 so that the load of the mobile terminal 21 asking for portability and miniaturization can be lightened.

Moreover, when for mobile terminal 21, it is possible to independently perform learning processing and prediction processing at high speed as data processing equipment, of course, the mobile terminal 21 is also able to be equipped with all the configuration of the prediction system 1 of FIG. 1.

### [An Example of the Input Time Series Data]

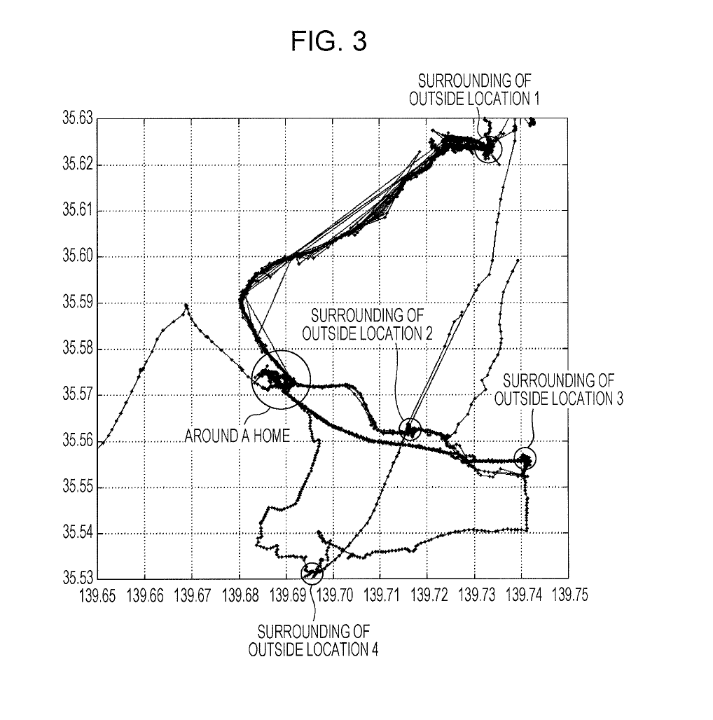

FIG. 3 shows the example of the time series data of the location data acquired by the prediction system 1. In FIG. 3, a horizontal axis expresses longitude and the vertical axis expresses latitude.

The time series data shown in FIG. 3 shows the time series data, of a experimenter accumulated in the period of about one and half months. As shown in FIG. 3, the time series data are mainly data with movement to four going-out places such as in the vicinity of a home, office and the like. In addition, the time series data has some missing data due to a failure in acquisition of a satellite.

In addition, the time series data shown in FIG. 3 are the examples of data different from the data used for the verification experiment mentioned later.

### [In Regard to Ergodic HMM]

Next, the prediction system 1 explains about Ergodic HMM adopted as a learning model.

FIG. 4 shows the example of HMM.

HMM is a state transition model which has a state and a transition between states.

FIG. 4 shows the example of HMM of three states.

In FIG. 4 (also subsequent figures are the same), round marks express states and arrows express state transitions. In addition, a state is also called a state node or a node simply corresponding to an above-mentioned user's action state.

In addition, in FIG. 4, sᵢ (i=1, 2, 3 in FIG. 4) expresses a state, and aᵢⱼ expresses in state transition probability from state sᵢ to state sⱼ. Furthermore, bⱼ(x) expresses the output probability density function that the observation value x is observed at the time of state transition to state sⱼ, and πᵢ expresses initial probability that state sᵢ is an initial state.

In addition, as the output probability density function bⱼ(x), for example, a mixed regular probability distribution is used.

Here, HMM (continuous HMM) is defined by state transition probability aᵢⱼ, output probability density function bⱼ(x ) and initial probability πᵢ. The state transition probability aᵢⱼ, output probability density function bⱼ(x) and initial probability πᵢ are called parameter of HMM λ={aᵢⱼ,bⱼ(x), πᵢ, i=1, 2, . . . , M, j=1, 2, . . . , M}. M represents the number of the states of HMM.

For a method to estimate parameter λ of HMM, maximum likelihood estimation method of Baum-Welch is used widely. Maximum likelihood estimation method of Baum-Welch is an estimation method of the parameters based on EM algorithm (EM(Expectation-Maximization) algorithm).

According to maximum likelihood estimation method of Baum-Welch, an estimation of parameter λ of HMM is performed to maximize a likelihood to be found from the occurrence probability that is the probability that the time series data are observed (occur) based on observed time series data x=x₁, x₂, . . . , x_{T}. Here, xₜ expresses a signal (the value of a sample) observed at the time t and T expresses the length (the number of the samples) of time series data.

For example, the maximum likelihood estimate method of Baum-Welch described above is disclosed in “Pattern Recognition and Machine Learning (Information Science and Statistics)”, Christopher M. BishopSpringer, New York, 2006, at page 333 (hereafter, called reference A).

In addition, although the maximum likelihood estimation method of Baum-Welch is a parameter estimate method based on the likelihood maximization, it does not guarantee the best fit but converges in a local site solution (a local minimum) depending on an initial value of structure and parameter λ of HMM.

HMM is used in sound recognition widely, but in HMM used in sound recognition, the number of states and fashion etc. of state transitions are generally decided beforehand.

FIG. 5 shows an example of HMM used in sound recognition.

HMM of FIG. 5 is called a left-to-right type. In FIG. 5, the number of states is 3 and the state transition is restrained by the structure allowing only self-transitions (state transition from state sᵢ to state sᵢ), and the state transition from a state on the left to a state on the right.

HMM, shown in FIG. 4, which does not have restrictions in a state transition, i.e., the state transition from arbitrary state sᵢ to arbitrary state sⱼ, to HMM, like HMM of FIG. 5, that there is a restriction in the state transition, is possible is called Ergodic HMM.

Although Ergodic HMM is HMM with the highest flexibility as a structure, for the case where the number of states increases, it will become difficult to estimate parameter λ.

For example, when the number of states of Ergodic HMM is 1000, the number of state transitions is set to 1 million (=1000×1000).

Therefore, in this case in regard to the state transition probability aᵢⱼ, for example, of the parameters λ, it is necessary to estimate 1 million state transition probability aᵢⱼ.

Thus, restrictions (sparse restrictions) that it is sparse structure can be applied in the state transition set up to a state, for example.

Here, a sparse structure is the structure where it is not a dense state transition like Ergodic HMM in which the state transition from an arbitrary state to an arbitrary state is possible, but it is a very limited structure where a state transition from a certain state can be done, In addition, even if it is a sparse structure, at least one state transition to other states exists, and there is self-transition.

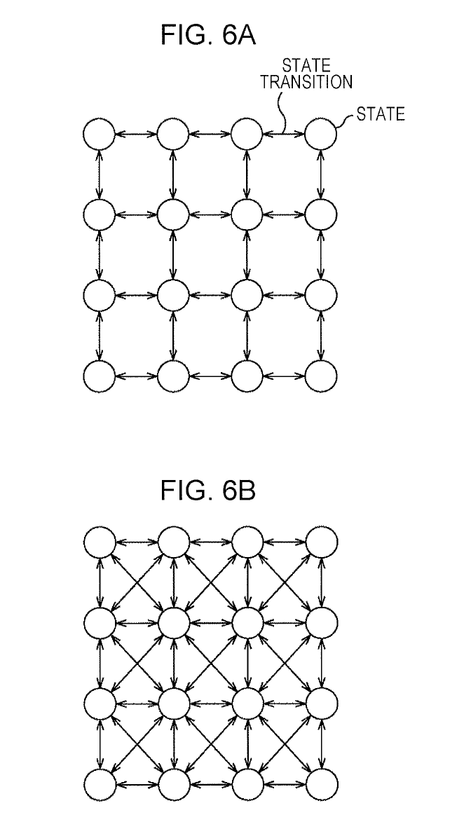

FIGS. 6A and 6B show HMM where sparse restrictions are given.

Here, in FIGS. 6A and 6B, the bidirectional arrow which connects two states expresses a state transition from one side of the two states to another side and a state transition from another side to one side. Moreover, in FIGS. 6A and 6B, for each state, self-transitions are possible and the illustration showing the self-transitions of the arrow is omitted.

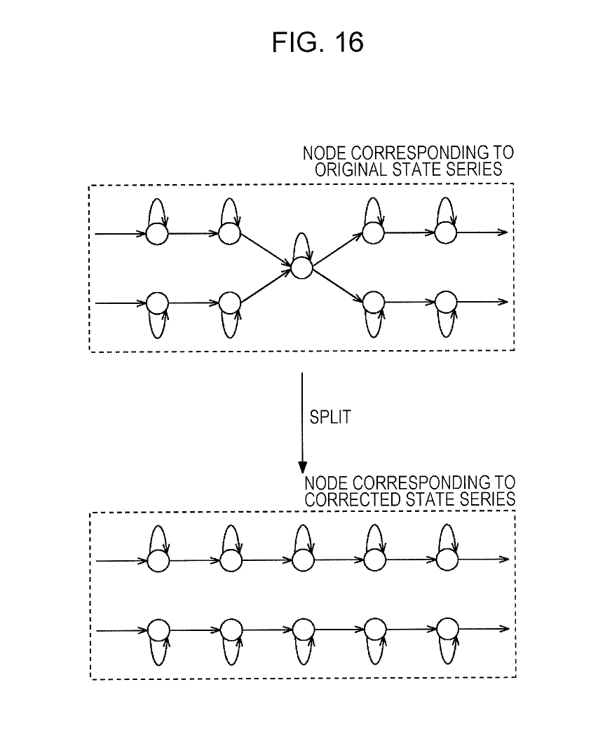

In FIGS. 6A and 6B, 16 states are arranged in the shape of a lattice on two-dimensional space. That is, at FIGS. 6A and 6B, four states are arranged in the transverse direction and four states are arranged also at the longitudinal direction.

If each distance of the states which adjoin in a transverse direction and distance of the states which adjoin in a longitudinal direction is now set to 1, FIG. 6A sets that distance is possible for the state transition to one or less state, and shows HMM where sparse restrictions are given that the state transition to other states is not possible.

Moreover, FIG. 6B sets that distance is possible for the state transition to the state not more than √2, and shows HMM where sparse restrictions are given that the state transition to other states is not possible.

In the example of FIG. 1, the location data which the GPS sensor 10 acquired is supplied to the time series data memory section 12 as time series data x=x₁, x₂, . . . , x_{T}. The action learning section 13 estimates the parameter λ of HMM showing a user action model using time series data x=x₁, x₂, . . . , x_{T} stored in the time series data memory section 12.

That is, it is considered that the data showing a user's movement locus of the location (latitude and longitude) of each time is observational data of the probability variable which has the normal distribution with the spread of a predetermined distributed value from one point on the map corresponding to either of the states sⱼ of HMM. The action learning section 13 optimizes one point and its distributed value on the map corresponding to each state sⱼ, and the state transition probability aᵢⱼ.

In addition, initial probability πᵢ of state sᵢ can be set as a uniform value. For example, initial probability πᵢ of each of M states sᵢ is set as 1/M. Moreover, the location data after predetermined processing of interpolation processing etc. is performed to the location data acquired by the GPS sensor 10 may be supplied to the time series data memory section 12 as time series data x=x₁, x₂, . . . , x_{T}.

The action recognition section 14 applies Viterbi method to the user action model (HMM) obtained by learning, and seeks the process (series of a state) (course) (henceforth called the maximum likelihood course) of the state transition which maximizes the degree of likelihood that location data x=x₁, x₂, . . . , x_{T} is observed from the GPS sensor 10. Thereby, the user's present action state, that is, the state sᵢ corresponding to a user's present location, is recognized.

Here, the Viterbi method is the algorithm which determines the course (the maximum likelihood course) which maximizes the value (occurrence probability) which was accumulated over the length T of the time series data x after processing the state transition probability aᵢⱼ which state transits into state sⱼ from state sᵢ at time t among courses of the state transitions that made each state sᵢ into the starting point and the probability (output probability obtained from the output probability density function bⱼ(x)), in its state transition, that the sample value xₜ of the time t among location data x=x₁, x₂, . . . , x_{T} is observed. The details of the Viterbi method are indicated by P.347 of the above-mentioned reference A.

### [Search Processing of the Course by the Action Prediction Section 15]

Next, search processing of the course by the action prediction section 15 is described.

Each state sᵢ of HMM obtained by learning expresses the predetermined point on a map (location) and can be considered to express the course to move from state sᵢ to state sⱼ when state sᵢ and state sⱼ are connected each other.

In this case, each point corresponding to state sᵢ can be classified into an end point, a passage point, a turnoff, or a loop. The end point is the point in which probability except for self-transitions may be extremely small (probability except for self-transitions is lower than the predetermined value), and is the point that is no point which can be moved to next. The passage point is a point with one point with one significant transition except for self-transitions, in other words, there is one point which is a point that can be moved to next. The turnoff is a point where two or more significant transitions except for self-transitions are available. In other words, it is two points which are points that can be moved to next. A loop is a point which is in agreement with either course passed so far.

When there is a different course during searching for the course to the destination, it is desired to show information such as demanded time and the like in regard to each course. Then, the following conditions are set up in order to search for a possible course in just proportion.

(1) Even when the course which branched once joins again, it is considered another course.

(2) When there is a point included in the course passed so far or the end point in the course, the search of the course ends.

The action prediction section 15 repeats classifying into the end point, the passage point, the turnoff, or the loop the points in which the state transitions as a following movement place are possible by making a starting point of the user's present action state recognized by the action recognition section 14, i.e., a user's present point to the termination condition of (2).

When the present point is classified into an end point, the action prediction section 15 ends search of this course after connecting the present point to the course so far.

On the other hand, when the present point is classified into a passage point, the action prediction section 15 moves to the following point after connecting the present point to the course so far.

Moreover, when it is classified that the present point is a turnoff, the action prediction section 15 connects the present point to the course so far and further reproduces the course so far the amount of only the number of branches, and connects it with a turnoff. And the action prediction section 15 moves with one of the turnoffs as a following point.

When it is classified that the present point is a loop, the action prediction section 15 ends search of this course without connecting the present point to the course so far. In addition, when reversing from the present point into a point behind the present point at the course, since the present point is contained in a loop, it is not taken into consideration.

### [Example of Search Processing]

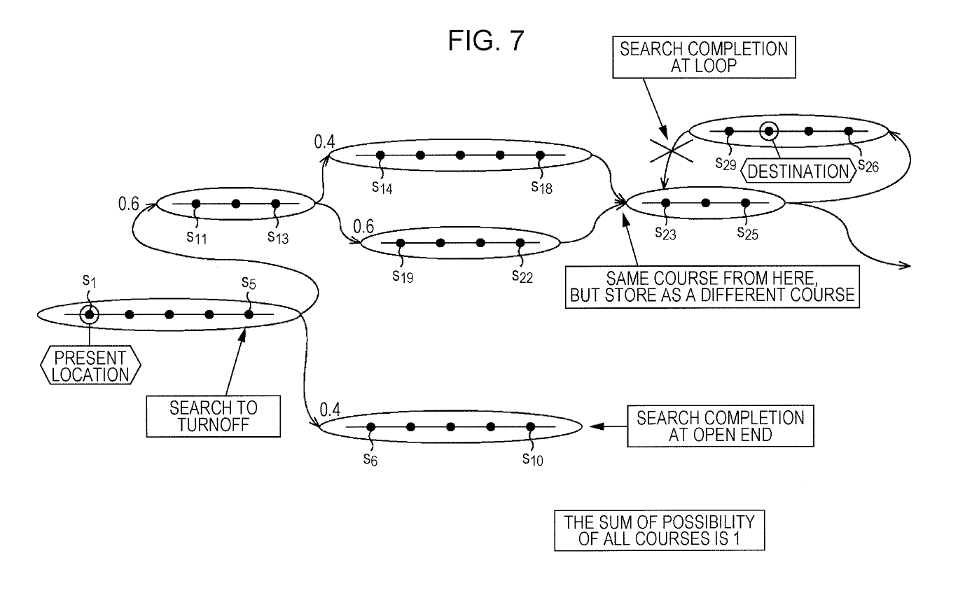

FIG. 7 shows a simple example of search processing of the course by the action prediction section 15.

When a state sᵢ is a present location, it will search for three kinds of courses finally in the example of FIG. 7. The 1st course is a course (henceforth course A) to a state s₁₀ via a state s₅, state s₆ and the like from a state s₁. The 2nd course is a course (henceforth course B) to a state s₂₆ from a state s₁ via a state S₅, a state s₁₁, a state s₁₄, and state s₂₃ and the like. The 3rd course is a course (henceforth course C) to a state s₂₆ from a state s₁ via a state s₅, a state s₁₁, a state s₁₉, and state s₂₃ and the like.

The action prediction section 15 calculates the probability (selection probability of a course) that each searched course is chosen. The selection probability of a course is searched for by sequentially carrying out the multiplication of the transition probability between the states which constitute a course. However, since it is not necessary to take into consideration when staying in the place only in consideration of the transition case into the following state, the selection probability of the course is searched for using the transition probability [aᵢⱼ] standardized except for self-transition probability from the state transition probability aᵢⱼ of each state obtained by learning.

The transition probability [aᵢⱼ] standardized except for self-transition probability can be expressed with the following equation (3).

$$[ {a}_{ij} ] = \frac{( 1 - {δ}_{ij} ) {a}_{ij}}{{\sum }_{j = 1}^{N} ( 1 - {δ}_{ij} ) {a}_{ij}} \qquad ( 3 )$$

Here, δ represents the Kronecker function, it is set to 1 only in the case where i and j of subscripts are same, and it is a function used as 0 in all other cases.

Therefore, for example, when the state transition probability aᵢⱼ of the state s₅ of FIG. 7 is the case that the self-transition probability a_{5, 5}=0.5, the transition probability a_{5, 6}=0.2, and the transition probability a_{5, 11}=0.3, the transition probability [a_{5, 6}] and transition probability [a_{5, 11}] in the case of branching into a state s₆ or the state s₁₁ from a state s₅ are set to 0.4 and 0.6, respectively.

When node number i of the state sᵢ of the course searched is (y₁, y₂, . . . , yₙ), the selection probability of the course can be expressed with the following equation (4) using the standardized transition probability [aᵢⱼ].

$$\begin{matrix}P ( {y}_{1} , {y}_{2} , . . . , {y}_{n} ) = [ {a}_{{y}_{1} {y}_{2}} ] [ {a}_{{y}_{2} {y}_{3}} ] . . . [ {a}_{{y}_{n - 1} {y}_{n}} ] \\ = {\prod }_{i = 1}^{n - 1} [ {a}_{{y}_{i - 1} {y}_{i}} ]\end{matrix} \qquad ( 4 )$$

In fact, since the standardized transition probability [aᵢⱼ] in a passage point is 1, it is sufficient if the sequential multiplication of the transition probability [aᵢⱼ] standardized at the time of branching is carried out.

In the example of FIG. 7, the selection probability of course A is 0.4. Moreover, the selection probability of course B is 0.24=0.6×0.4. The selection probability of course C is 0.36=0.6×0.6. And sum of the selection probabilities of the calculated course is 1=0.4+0.24+0.36, and it can be understood that neither more nor less of a search is realizable.

As mentioned above, each course, which is searched based on the its present location and its selection probability, are supplied to the destination prediction section 16 from the action prediction section 15.

The destination prediction section 16 extracts a course including the destination specified by a user from the course searched by the action prediction section 15, and predicts the time to the destination in regard to each extracted course.

For example, for the example of FIG. 7 the courses which include the state s₂₈ which is a destination among three courses from A to C which was searched for are course B and course C. The destination prediction section 16 passes along course B or course C, and predicts the time until the state s₂₈ which is a destination is reached.

Suppose that the present location of the present time t₁ is in a state s_{y1} and the determined courses in time (t₁, t₂, . . . , t_{g}) are (s_{y1}, s_{y2}, . . . , s_{yg}). In other words, suppose that node number i of the state sᵢ of the determined course is (y₁, y₂, . . . , y_{g}). Hereafter, for simplicity, the state sᵢ corresponding to a position may be expressed only with the node number i.

Since present location y₁ in the present time t₁ is fixed by recognition of the action recognition section 14, the probability P_{y1} (t₁) for the present location of the present time t₁ to be y₁ is 1. Moreover, the probability that other states other than y₁ exist at the present time t₁ is 0.

On the other hand, probability P_{yn}(tₙ) of a node number yₙ at the predetermined time tₙ is expressed by a following equation.

P_{y}_{ₙ}(tₙ)=P_{y}_{ₙ}(tₙ−1)a_{y}_{ₙ}_{y}_{ₙ}+P_{y}_{ₙ₋₁}(tₙ−1)a_{y}_{ₙ₋₁}_{y}_{ₙ} (5)

The first clause of the right-hand side of an equation (5) represents the probability at the time of conducting self-transitions in the position yₙ from the first, and the second clause of the right-hand side represents the probability in the case of transition in the location yₙ from location yₙ₋₁ that was one location before. At equation (5), unlike calculation of the selection probability of a course, the state transition probability aᵢⱼ acquired by learning is used as it is.

The predicted value <t_{g}> of the time t_{g} reaching to destination y_{g} can be expressed using “The probability of moving to destination y_{g} at time t_{g} at location y_{g-1} that was one location before destination y_{g} at time t_{g-1} that was one period before”.

$$〈 {t}_{g} 〉 = {\sum }_{t} {t}_{g} ( \frac{{P}_{{x}_{g - 1}} ( {t}_{g - 1} - 1 ) {a}_{{x}_{g - 1} {x}_{g}}}{{\sum }_{t} {P}_{{x}_{g - 1}} ( {t}_{g} - 1 ) {a}_{{x}_{g - 1} {x}_{g}}} ) \qquad ( 6 )$$

That is, a predicted value <t_{g}> is expressed with the expected value of the time from the present time up to “The time of moving to state s_{yg} at time t_{g} at state s_{yg-1} that was one location before state s_{yg} at time t_{g-1} that was one time period before”.

### [Example of Detailed Configuration for the Action Learning Section 13]

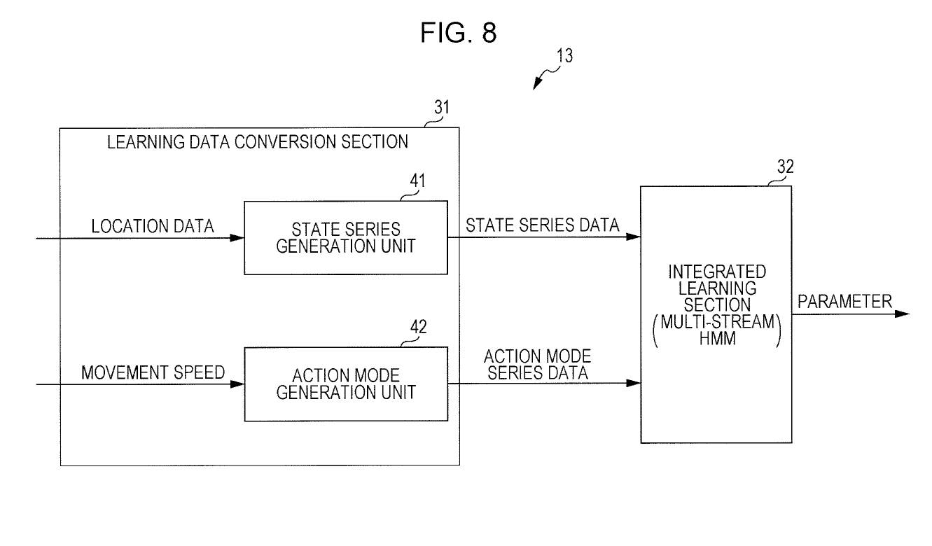

FIG. 8 shows an example of configuration that the action learning section 13 of FIG. 1 is able to adopt.

The action learning section 13 learns a user's movement locus and action state simultaneously using the time series data of the location and the movement speed stored in the time series data memory section 12 (FIG. 1).

The action learning section 13 is constituted by the learning data conversion section 31 and the integrated learning section 32.

The learning data conversion section 31 is constituted by the state series generation unit 41 and the action mode generation unit 42. The state series generation unit 41 changes the time series data of location data into the time series data (state series data) of the state node sᵢ, and supplies the data to the integrated learning section 32. The action mode generation unit 42 changes the movement speed data into action mode's time series data (action mode series data), and supplies the data to the integrated learning section 32.

The time series data of the location data supplied from the time series data memory section 12 are supplied to the state series generation unit 41. The same configuration as the action recognition section 14 of FIG. 1 can be used for the state series generation unit 41. That is, the state series generation unit 41 recognizes a user's present action state corresponding to a user's input present location from the user action model based on the parameter obtained by learning. Then, the state series generation unit 41 sequentially supplies the present state node sᵢ of the user as a recognition result to the integrated learning section 32.

The time series data of the movement speed supplied from the time series data memory section 12 are supplied to the action mode generation unit 42. The action mode generation unit 42 recognizes the action state of the user corresponding to the movement speed supplied using the parameter obtained by learning the user's action state as the stochastic state transition model, and sequentially supplies a recognition result to the integrated learning section 32 as action mode. As a user's action state which the action mode generation unit 42 recognizes, at least a stationary state and a movement state are necessary. Moreover, action mode of a movement state can be further classified according to the transportation means of walking, bicycle, car, etc.

### [Classification of Action Mode]

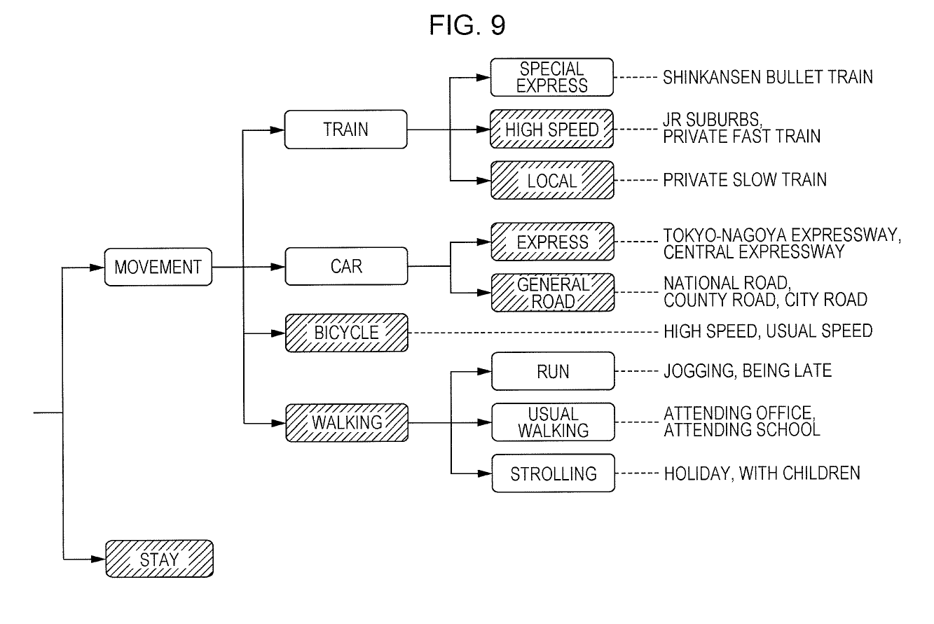

FIG. 9 is a figure explaining a user's action state (action mode) which the action mode generation unit 42 recognizes.

As shown in FIG. 9, a user's action state can be first classified into a stationary state and a movement state. Since at least a stationary state and a movement state are necessary as mentioned above as a user's action state which the action mode generation unit 42 recognizes, it is indispensable to classify into these two states in the prediction system 1.

Furthermore, a movement state can be classified into train, car (including bus etc.), bicycle, and walking according to a transportation means. T train can be further classified into special express, high speed, a local, etc., and a car can be further classified into express, a general road, etc. Moreover, walking can be classified into running, usual walking, stroll, etc.

Suppose in the prediction system 1 that a user's action state is classified into “stationary”, “train (high speed)”, “train (local)”, “car (express)”, “car (general road)”, “bicycle”, and “walking” as shown with oblique lines in FIG. 9. In addition, “train (special express)” was omitted because learning data was not obtained.

It goes without saying that the method of action mode's classification is not limited to the example shown in FIG. 9. Moreover, since transition of the movement speed by a transportation means does not change greatly with users, the time series data of the movement speed as learning data do not have to belong to the user who is an objective for recognition.

Returning to FIG. 8, the integrated learning section 32 integrates learning of the time series data of two or more events (modal) by a stochastic state transition model. State series data is supplied as time series data of the 1^{st} event and action mode series data is supplied as time series data of the 2^{nd} event to the integrated learning section 32. Therefore, the integrated learning section 32 learns the parameter λ of the multi-stream HMM as a stochastic state transition model showing a user's action state using state series data and action mode series data.

The multi-stream HMM is HMM that the data which follows two or more different probability laws from the state node which has the same transition probability as the usual HMM is output. In the multi-stream HMM, output probability density function bⱼ(x) is separately prepared for every time series data among parameters λ.

In this example, since time series data are two of state series data and action mode series data, the output probability density function b1ⱼ(x) that outputs probability density function bⱼ(x) corresponds to the time series data of a place index and output probability density-function b2ⱼ(x) corresponding to action mode's time series data are prepared. Output probability density function b1ⱼ(x) is the probability that the index on a map becomes x when the state node of the multi-stream HMM is j. Output probability density function b2ⱼ(x) is the probability that action mode becomes x when the state node of the multi-stream HMM is j. Therefore, at the multi-stream HMM, a user's action state is learned (integrated learning) in the form where the index on a map and the action mode are associated.

More specifically, the integrated learning section 32 learns the probability of each state node (probability that which state node is output) and action mode's probability which each state node outputs (probability that which action mode is output). According to the integrated model (multi-stream HMM) obtained by learning, the state node where a “stationary state” action mode is easy to be output stochastically is obtained. Then, a location of a destination candidate can be recognized from the recognized state node. Furthermore, the location of the destination can be recognized from latitude and longitude distributions which show the location of the destination candidate.

As mentioned above, the place where the state node has a high probability that the observed action mode is a “stationary state” is estimated to be the location where the user is stationary. Then, as mentioned above, since most of cases where locations in which become “stationary state” are destinations, these stationary places can be estimated as destinations.

The integrated learning section 32 supplies the parameter λ of the multi-stream HMM showing a user's action state obtained by learning to the action recognition section 14, the action prediction section 15, and the destination prediction section 16.

In addition, in the example mentioned above the time series data of the position supplied from the time series data memory section 12 and movement speed were transformed into state series data and action mode series data by making a model by HMM in the state series generation unit 41 and the action mode generation unit 42.

However, the data of a position and movement speed may be transformed into state series data and action mode series data by methods other than this.

For example, on the action mode, the existence of the user's movement is detected from detection results of acceleration or the like using motion sensors such as an acceleration sensor, a gyroscope sensor or the like, independently of the GPS sensor 10, and it may be possible to acquire the determination results that determines the action mode. In this case, it is possible to skip the action mode generation unit 42.

### [Prediction Processing for Arrival Time to Destination]

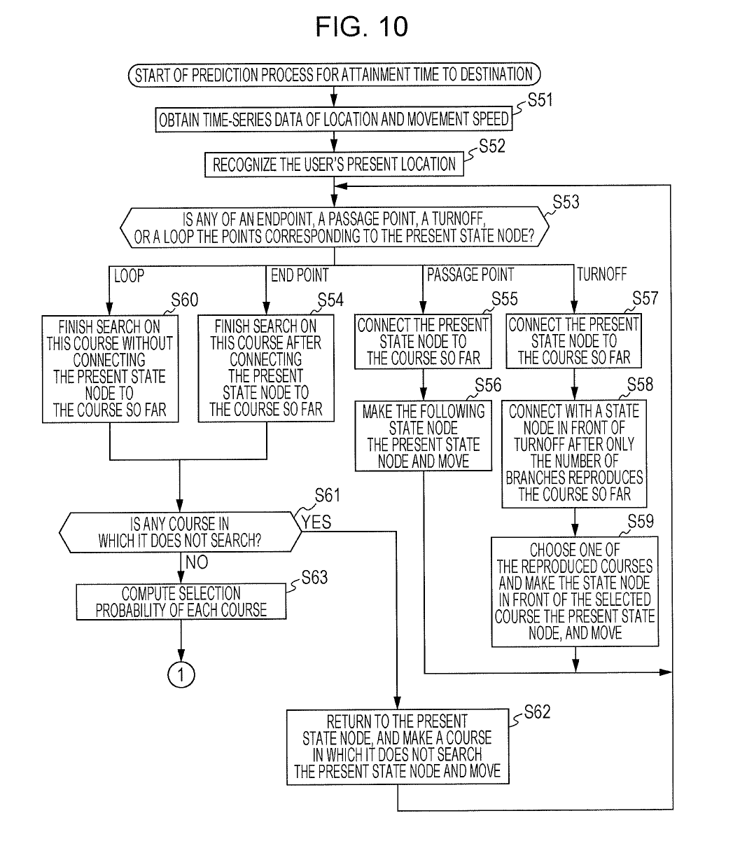

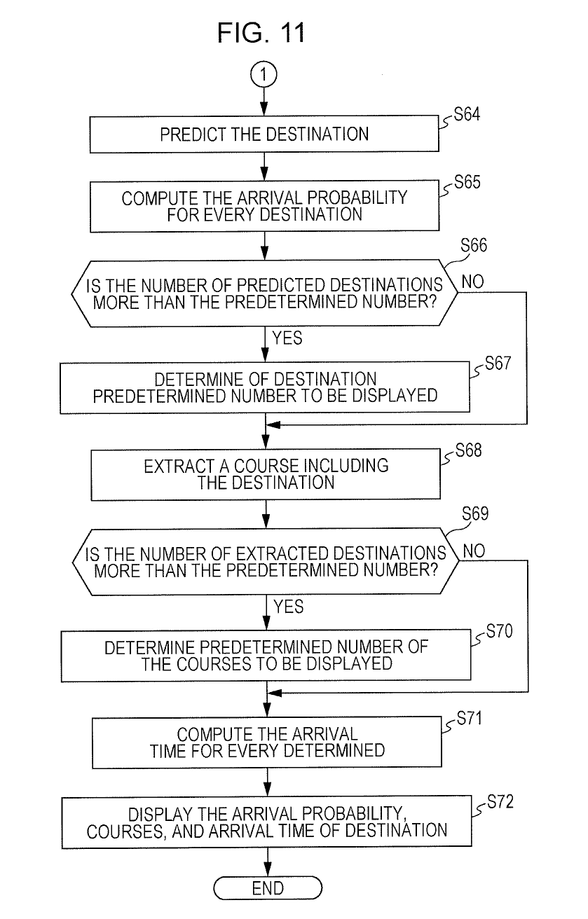

Next, the prediction processing for arrival time to destination by the prediction system 1 of FIG. 1 is described with reference to flow charts of FIGS. 10 and 11.

For the first time, in step S51, the action recognition section 14 acquires the time series data of a location and movement speed. That is, in step S51, the GPS sensor 10 supplies the time series data of location data to the speed computing section 11, and the speed computing section 11 computes movement speed from the data of a location and sequentially supplies the data of a location and movement speed to the action recognition section 14. The time series data on location and movement speed of the predetermined number of samples are temporarily stored in the action recognition section 14.

In step S52, the action recognition section 14 recognizes a user's present action state from the user activity model based on the parameter obtained by learning. That is, the action recognition section 14 recognizes a user's present location. Then, the action recognition section 14 supplies the node number of a user's present state node to the action prediction section 15.

In step S53, the action prediction section 15 determines whether the point corresponding to the state node (hereinafter, called appropriately the present state node) for which it is currently searching is any of an end point, a passage point, a turnoff, or a loop. Immediately after processing of step S52, the state node corresponding to a user's present location becomes the present state node.

At step S53, when the point corresponding to the present state node is determined to be an end point, this process proceeds to step S54. Then, the action prediction section 15 connects the present state node to the course so far and the process ends the search of this course, and proceeds to step S61. In addition, since the course so far does not exist when the present state node is a state node corresponding to its present location, a connection process is not performed. The same processes are applied to step S55, S57, and S60.

At step S53, when the point corresponding to the present state node is determined to be a passage point, this process proceeds to step S55. Then, the action prediction section 15 connects the present state node to the course so far. Then, in step S56, the action prediction section 15 moves with the following state node as the present state node. Process returns to step S53 after process of step S56.

At step S53, when the point corresponding to the present state node is determined to be a turnoff, this process proceeds to step S57 and the action prediction section 15 connects the present state node with the course so far. Then, in step S58, the action prediction section 15 connects a state node in front of a turnoff after reproducing only the number of branches the course so far. Furthermore, in step S59, the action prediction section 15 chooses one of the reproduced courses and moves with the state node before the selected course as the present state node. Process continues again from step S53 after process of step S59.

On the other hand, at step S53, when the point corresponding to the present state node is determined to be a loop, this process proceeds to step S60. Then, the action prediction section 15 ends search of this course without connecting the present state node with the course so far, and proceeds to step S61.

In step S61, the action prediction section 15 determines whether or not there is any course which it has not searched. At step S61, when it determines that there is a course which it has not searched, this process proceeds to step S62. Then, the action prediction section 15 returns to the present state node, and makes a following state node of a course which it has not searched as the present state node and moves. Process returns to step S53 after process of step S62. Thereby, in regard to the course which it has not searched, search of a course is performed until search is completed by the end point or a loop.

When the action prediction section 15 determines that there is no course which it has not searched at step S61, this process proceeds to step S63 and the action prediction section 15 calculates the selection probability (occurrence probability) of each searched course. The action prediction section 15 supplies each course and its selection probability to the destination prediction section 16.

The user's present location has been recognized by processing from step S51 to step S63 of FIG. 10 and searched in just proportion for the course which the user can take from there, and after the selection probability of each course is calculated, this process proceeds to step S64 of FIG. 11.

In step S64, the destination prediction section 16 predicts a user's destination. Specifically, the destination prediction section 16 first enumerates destination candidates. The destination prediction section 16 makes a destination candidate of the location where a user's action state is in a stationary state. Then, the destination prediction section 16 determines the destination candidate on the course, which was searched for by the action prediction section 15 among enumerated destination candidates, as the destination.

In step S65, the destination prediction section 16 calculates the arrival probability for every destination. That is, for the destination where two or more courses exist, the destination prediction section 16 calculates the sum of the selection probability of two or more of the courses as arrival probability of the destination. For the destination only with one course, selection probability of a course is the arrival probability of the destination as it is.

At step S66, the destination prediction section 16 determines whether there are more predicted destinations than the predetermined number. When it determines that there are more predicted destinations than the predetermined number at step S66, the process proceeds to step S67 and the destination prediction section 16 determines the destinations of the predetermined number displayed on the display section 18. For example, the destination prediction section 16 can determine the predetermined number of courses in the order of the destinations with the highest arrival probabilities.

On the other hand, when the destination prediction section 16 determines at step 66 that the number of the predicted destinations is not more than the predetermined number, step S67 is skipped. That is, in this case, all destinations predicted are displayed on the display section 18.

In step S68, the destination prediction section 16 extracts courses including the predicted destination from the course which was searched for by the action prediction section 15. When two or more destinations are predicted, a course is extracted for each predicted destination.

In step S69, the destination prediction section 16 determines whether there are more extracted courses than the predetermined number set up as a presentation number beforehand.

When the destination prediction section 16 determines at step S69 that there are more extracted courses than the predetermined number, the process proceeds to step S70 and the destination prediction section 16 determines the course of the predetermined number displayed on the display section 18. For example, the destination prediction section 16 can determine the predetermined number of the course in the order of the courses with the highest possibilities of being chosen.

On the other hand, when the destination prediction section 16 determines at step S69 that the number of extracted courses is not more than the predetermined number, the process of step S70 is skipped. That is, in this case, all courses for arriving at the destination are displayed on the display section 18.

In step S71, the destination prediction section 16 calculates the arrival time of each course for which it is determined that it will display on the display section 18, and supplies the signal of the picture which displays the arrival probability of the destination and the course and arrival time to the destination to the display section 18.

In step S72, the display section 18 displays the arrival probability of the destination and the course and arrival time to the destination, and ends the process based on the signal of the picture supplied from the destination prediction section 16.

As mentioned above, according to the prediction system 1 of FIG. 1, it is possible to predict the destination from the time series data of a location and movement speed and to compute the arrival probability of the destination and the course and arrival time to the destination, and suggest those to the user.

However, in the prediction system 1 of FIG. 1, the two-step process which considers the output result by HMM as the input of latter HMM as configuration of a learning machine is adopted. That is, as shown in FIG. 8, the two-step process which considers the output result of HMM in the state series generation unit 41 as the input of HMM in the integrated learning section 32 is adopted. Learning time in this two-step process takes twice as long, and its processing load was large.

### 2. An Embodiment of the Present Invention

Wherein, an embodiment of the invention is described that can learn the learning parameter of the prediction system which more easily predicts the probability, course, and elapsed time to reach a specific place or the place where a specific action is performed in the near future after the present time rather than the method of Japanese Patent Application No. 2009-208064 mentioned above. That is, a preferred embodiment of the present invention will be described.

### Example of Configuration of the Action Learning Section in the Prediction System to which the Embodiment of the Present Invention is Applied

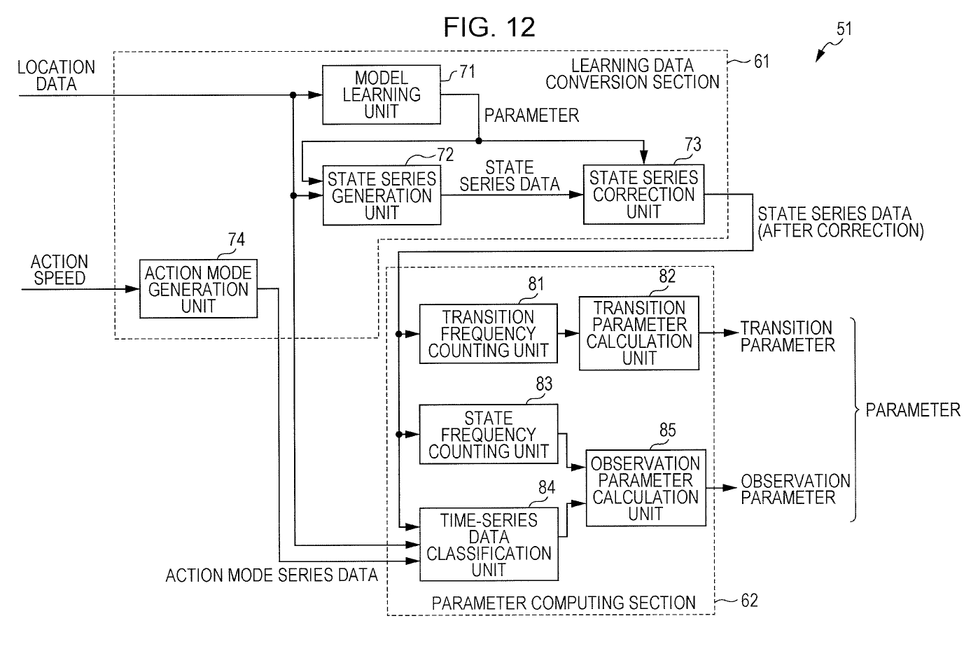

FIG. 12 is a block diagram showing the example of the configuration of the action learning section in the prediction system to which the embodiment of present invention is applied.

The configuration of prediction system to which the embodiment of present invention is applied adopts a configuration similar to the prediction system 1 of FIG. 1. However, by replacing the action learning section 13 in the prediction system 1 of FIG. 1 with the action learning section 51 of FIG. 12, learning (computing) of the parameter for supplying the action recognition section 14, the action prediction section 15, and the destination prediction section 16 becomes easier.

The action learning section 51 is configured to have a learning data conversion section 61 and a parameter computing section 62. The learning data conversion section 61 corresponds to the learning data conversion section 31 (FIG. 8) in the action learning section 13 of FIG. 1 and the parameter computing section 62 corresponds to the integrated learning section 32 (FIG. 8) in the action learning section 13 of FIG. 1.

The learning data conversion section 61 is configured to have the model learning unit 71, the state series generation unit 72, the state series correction unit 73, and the action mode generation unit 74. Three pars of the model learning unit 71, the state series generation unit 72, and the state series correction unit 73 correspond to the state series generation unit 41 of FIG. 8, and the action mode generation unit 74 corresponds to the action mode generation unit 42 in FIG. 8.

On the other hand, the parameter computing section 62 is configured to have the transition frequency counting unit 81, the transition parameter calculation unit 82, the state frequency counting unit 83, the time series data classification unit 84, and the observation parameter calculation unit 85.

Each unit which constitutes the learning data conversion section 61 and the parameter computing section 62 is described in the following.

The model learning unit 71 learns a user's action state as a stochastic state transition model based on the time series data of the location data supplied from the time series data memory section 12. Since time series data are data in which a user's location is shown, a user's action state learned as a stochastic state transition model becomes a user's movement locus. As a stochastic state transition model used for learning, a model where sparse restrictions are given to Ergodic HMM is adopted like an above-mentioned example.

The model learning unit 71 supplies the parameter of the learning model (HMM) obtained by learning to the state series generation unit 72 and the state series correction unit 73.

The state series generation unit 72 changes into the time series data of the state node sᵢ corresponding to a user's present location (course) the time series data of the location data supplied from the time series data memory section 12, generates state series data, and supplies it to the state series correction unit 73. Specifically, the state series generation unit 72 recognizes the present action state of the user that corresponds to a user's input present location from the user activity model based on the parameter supplied from the model learning unit 71. Then, the state series generation unit 72 sequentially supplies the present state node sᵢ of the user as a recognition result to the state series correction unit 73.

The state series correction unit 73 corrects the state series data supplied from the state series generation unit 72 if necessary, and supplies the state series data after correction to the transition frequency counting unit 81, the state frequency counting unit 83, and the time series data classification unit 84. When the correction of state series data is not made in the state series correction unit 73, the state series data supplied from the state series generation unit 72 is supplied to the transition frequency counting unit 81, the state frequency counting unit 83, and the time series data classification unit 84 as it is. Therefore, hereinafter, there is an explanation of when there is no correction of state series data in the state series generation unit 72 in the beginning, and the correction process performed in the state series generation unit 72 is described after that.

The action mode generation unit 74 generates action mode series data, i.e., action mode's time series data from the time series data of the movement speed supplied from the time series data memory section 12, and supplies the data to the time series data classification unit 84.

The action mode generation unit 74 may generate time series data of action mode by the same method as the action mode generation unit 42 of FIG. 8 mentioned above, and may generate time series data of action mode by another method. Moreover, in the similar way with the method of Japanese Patent Application No. 2009-208064 mentioned above, when time series data of action mode are supplied from the outside, the action mode generation unit 74 can be omitted and the time series data of the action mode from the outside can be used as it is.

The transition frequency counting unit 81 counts the frequency of each transition state for all the state series data supplied from the state series correction unit 73. Namely, if the transition frequency counting unit 81 expresses the frequency (the count value) of the course to move to the state node sⱼ from the state node sᵢ as nᵢⱼ, the frequency nᵢⱼ (i=1 to N, j=1 to N, and N are the node numbers (=the number of nodes) of the last of time series data) of each state transition is obtained for all the state series data supplied from the state series correction unit 73.

The transition parameter calculation unit 82 calculates the transition parameter corresponding to the state transition probability aᵢⱼ of HMM. Specifically, the transition parameter calculation unit 82 calculates the transition probability Aᵢⱼ by an equation (7) based on the frequency nᵢⱼ of each state transition supplied from the transition frequency counting unit 81.

$${A}_{ij} = \frac{{n}_{ij}}{{\sum }_{j = 1}^{N} {n}_{ij}} \qquad ( 7 )$$

By the equation (7), the transition probability Aᵢⱼ which state transitions did not occur becomes zero. In the learning model using the known HMM, if the number of times of repetition is not large enough, probability of the transitions which did not occur in the past is difficult to be made small. However, according to the equation (7), there is the feature that transition probability Aᵢⱼ which state transitions do not occur can be made to be zero. This feature is an important merit to reduce searching for unnecessary courses in the algorithm which searches for the possibility of a future course.

The transition parameter calculation unit 82 outputs the calculated transition probability Aᵢⱼ as a transition parameter corresponding to the state transition probability aᵢⱼ of HMM.

The state frequency counting unit 83 counts state frequencies for all the state series data supplied from the state series correction unit 73. That is, the state frequency counting unit 83 counts the total cntᵢ of each state node sᵢ, for all the state series data supplied from the state series correction unit 73. The total cntᵢ of each state node sᵢ, a result of a count, is supplied to the observation parameter calculation unit 85.

State series data is supplied from the state series correction unit 73 to the time series data classification unit 84. Moreover, the time series data of location data is supplied from the time series data memory section 12 to the time series data classification unit 84 and the time series data of action mode are supplied from the action mode generation unit 74 to the time series data classification unit 84.

The time series data classification unit 84 classifies and groups every state node the location data x sequentially supplied from the time series data memory section 12. The set data Xᵢ of the location data in state sᵢ can be expressed with the following equation (8).

Xᵢ={x_{i, 1}, x_{i, 2}, . . . , x_{i, cnt}_{ᵢ}} (8)

Since the total of the state node sᵢ is cntᵢ, the number of the element of the set data Xᵢ becomes cntᵢ. In addition, the data x of the location that is each element of the set data Xᵢ is, in detail, three-dimensional data, including latitude, longitude, and time, but it is abbreviated so as to be expressed in one dimension.

Moreover, the time series data classification unit 84 classifies and groups every state node of the action mode m sequentially supplied from the action mode generation unit 74. Set data Mᵢ of action mode in the state node sᵢ can be expressed with the following equation (9).

Mᵢ={m_{i, 1}, m_{i, 2}, . . . , m_{i, cnt}_{ᵢ}} (9)

The number of the element of the set data Mᵢ in an equation (9) is also cntᵢ.

The time series data classification unit 84 supplies the classification result having classified location data and time series data of action mode for every state node to the observation parameter calculation unit 85 as mentioned above. In other words, the time series data classification unit 84 supplies the set data X of each state node and the set data M to the observation parameter calculation unit 85.

The observation parameter calculation unit 85 calculates the observation parameter of location data and each time series data of action mode in regard to all the state nodes contained in the state series data supplied from the state series correction unit 73.

The observation parameter calculation unit 85 as an observation parameter of the time series data of location data calculates average value μᵢ and standard deviation σᵢ of the state node sᵢ using total cntᵢ of the state node sᵢ from the state frequency counting unit 83 and the set data Xᵢ from the time series data classification unit 84.

$$\begin{matrix}{μ}_{i} = \frac{1}{{cnt}_{i}} {\sum }_{j = 1}^{{cnt}_{i}} {x}_{i , j} & ( 10 ) \\ {σ}_{i} = \sqrt{\frac{1}{{cnt}_{i}} {\sum }_{j = 1}^{{cnt}_{i}}} {x}_{i , j}^{2} - {μ}_{i}^{2} & ( 11 )\end{matrix}$$

Average value μᵢ and standard deviation σᵢ of this state node sᵢ are observation probabilities of location data x in state node sᵢ, and correspond to output probability density function b1ᵢ(x) of multi-stream HMM which the integrated learning section 32 (at FIG. 8) outputs as mentioned above.

In addition, given the case where there are few elements, it may prepare the restrictions in regard to standard deviation σᵢ where there are restrictions when it is larger than a predetermined value. Or, the standard deviation learned in the model learning unit 71 may be diverted.

Furthermore, the observation parameter calculation unit 85 computes the appearance frequency P(sᵢ|m) of each action mode m expressed with the following equation (12) to action mode's set data Mᵢ in the state node sᵢ as an observation parameter of time series data of action mode.

$$P ( {s}_{i} \vert m ) = \frac{1}{{cnt}_{i}} N ( {M}_{i} = m ) \qquad ( 12 )$$

In the equation (12), N (Mᵢ=m) represents the number of action mode m in the inside of the set data Mᵢ.

The appearance frequency P(sᵢ|m) of this action mode m is an observation probability of action mode m in the state node sᵢ, and corresponds to an output probability density-function b2ᵢ(x) of the multi-stream HMM which the integrated learning section 32 (in FIG. 8) mentioned above outputs.

The observation parameter calculation unit 85 outputs an average value standard deviation σᵢ, and the appearance frequency P(sᵢ|m) of each state which is location data and an observation probability of action mode as an observation parameter.

As mentioned above, the parameter computing section 62 can compute the parameter of the stochastic state transition model of the 1^{st} event and the 2^{nd} event from the state series data supplied from the state series correction unit 73 and the action mode series data supplied from the action mode generation unit 74.

### [Parameter Learning Processing]

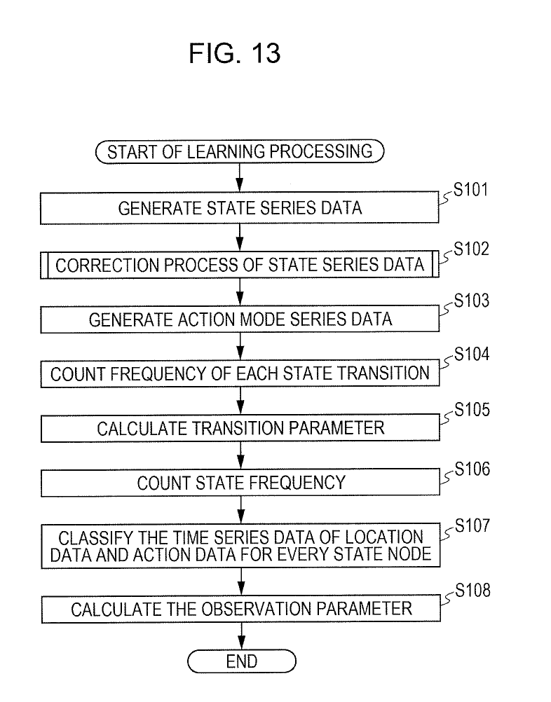

With reference to the flow chart of FIG. 13, the learning processing which the action learning section 51 of FIG. 12 performs is described. In addition, learning processing by the model learning unit 71 is performed before this learning processing, and the parameter as a learning result will be supplied to the state series generation unit 72 and the state series correction unit 73.

In the beginning, in step S101, the state series generation unit 72 generates state series data from the time series data of the location data supplied from the time series data memory section 12. Namely, the state series generation unit 72 transforms the time series data of location data into the time series data of the state node sᵢ, and supplies the data to the state series correction unit 73.

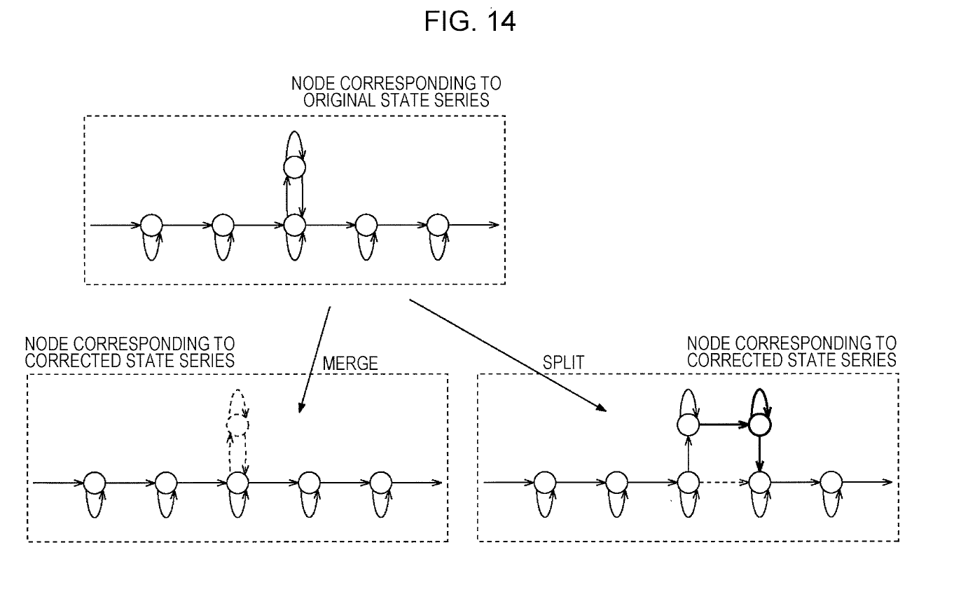

In step S102, the state series correction unit 73 performs the state series data correction processing to the state series data supplied from the state series generation unit 72 and the state series data after the correction is supplied to the transition frequency counting unit 81, the state frequency counting unit 83, and the time series data classification unit 84. The details of state series data correction processing are mentioned with references from FIG. 14 to FIG. 18 later. When there is no necessity for correction of state series data, the state series data supplied from the state series generation unit 72 is supplied to the transition frequency counting unit 81, the state frequency counting unit 83, and the time series data classification unit 84 as it is.

In step S103, the action mode generation unit 74 generates action mode series data from the time series data of the movement speed supplied from the time series data memory section 12, and supplies it to the time series data classification unit 84.

Processing of step S103 may be performed before processing of steps S101 and S102 mentioned above, and may be performed in parallel to processing of steps S101 and S102.

In step S104, the transition frequency counting unit 81 counts the frequency of each state transition for all the state series data supplied from the state series correction unit 73. That is, the transition frequency counting unit 81 obtains the frequency nᵢⱼ (i=1 to N, j=1 to N, and N are the node numbers (the number of nodes) of the last of time series data) of each state transition.

In step S105, the transition parameter calculation unit 82 calculates the transition parameter corresponding to the state transition probability aᵢⱼ of HMM. Specifically, the transition parameter calculation unit 82 calculates the transition probability Aᵢⱼ by the equation (7) mentioned above based on the frequency nᵢⱼ of each state transition supplied from the transition frequency counting unit 81. The transition parameter calculation unit 82 outputs the calculated transition probability Aᵢⱼ as a transition parameter corresponding to the state transition probability aᵢⱼ of HMM.

In step S106, the state frequency counting unit 83 counts state frequency for all the state series data supplied from the state series correction unit 73. That is, the state frequency counting unit 83 counts the total cntᵢ of each state node sᵢ for all the state series data supplied from the state series correction unit 73. The total cntᵢ of each state node sᵢ which is a result of the count is supplied to the observation parameter calculation unit 85.

In step S107, the time series data classification unit 84 classifies location data and the time series data of action mode for every state node. Namely, the time series data classification unit 84 classifies and groups every state node of the location data x sequentially supplied from the time series data memory section 12. Moreover, the time series data classification unit 84 classifies and groups every state node of the time series data of the action mode supplied from the action mode generation unit 74.

In step S108, the observation parameter calculation unit 85 calculates each of the observation parameters of time series data of location data and action mode in regard to all the state nodes contained in the state series data supplied from the state series correction unit 73.

Specifically, the observation parameter calculation unit 85 calculates average value μᵢ and standard deviation σᵢ of the state node sᵢ using total cntᵢ of the state node sᵢ from the state frequency counting unit 83 and the set data Xᵢ from the time series data classification unit 84.

Moreover, the observation parameter calculation unit 85 computes the appearance frequency P(sᵢ|m) of each action mode m expressed with an equation (12) to the set data Mᵢ of the action mode in the state node sᵢ.

In step S108, if each observation parameter of time series data of location data and action mode obtained by calculation is supplied to the action recognition section 14, the action prediction section 15, and the destination prediction section 16, the observation parameter calculation unit 85 ends the learning processing of FIG. 13.

According to the learning processing of FIG. 13, while the integrated learning section 32 of the action learning section 13 of FIG. 8 obtains the parameter to output by learning of HMM, the parameter computing section 62 of the action learning section 51 of FIG. 12 can obtain the parameter to output by the statistical procedure. Therefore, the parameter which the action recognition section 14, the action prediction section 15, and the destination prediction section 16 use for prediction processing can be obtained more easily. That is, the learning parameter for predicting the probability, course, and elapsed time to reach a specific place or the place where a specific action is performed in the future after the present time can be obtained more easily.

### [Description of Correction Processing of the State Series Data by the State Series Correction Unit 73]

Next, the correction processing of state series data which the state series correction unit 73 performs is described.

The state series correction unit 73 corrects the state series data supplied from the state series generation unit 72 according to a predetermined rule, and supplies the state series data after correction to the transition frequency counting unit 81, the state frequency counting unit 83, and the time series data classification unit 84.

In present embodiment of this invention, the state series correction unit 73 corrects the state series data supplied from the state series generation unit 72 so that the data may become state series data of a left-to-right type.

For present embodiment of this invention, the state series data supplied from the state series generation unit 72 is data showing a user's movement locus corresponding to a user's location which the GPS sensor 10 acquired. It is presumed that movement of a user can be approximated to state transitions model of a left-to-right type from a certain destination to other destinations. Moreover, although the same place may be expressed with two or more state nodes while a user is stationary at a place for a long time, it is presumed that it can be aggregated together to one state node.

The state series correction unit 73 makes the correction which simplifies the state series data supplied from the state series generation unit 72 so that the data may become state series data of a left-to-right type.

It is desirable to acquire beforehand the time series data of the location data stored in the time series data memory section 12 so that it may be easy to respond to the state series data of a left-to-right type by the data series divided finely so as not to be one data series but into data for every day, for every going or returning, or for every destination (stationary place) or the like. Or, it is desirable to use the time series data of one location data stored in the time series data memory section 12 after dividing finely into data for every day, for every going or returning, or for every destination (stationary place) or the like.

FIG. 14 shows the correction processing by the state series correction unit 73.

In order to correct so that state series data satisfies left-to-right restrictions, at first, the state series correction unit 73 searches at state series data for whether there is any loops, i.e., a portion which returns to the same state node. Then, when a loop is detected, the state series correction unit 73 merges the loop (the state node is deleted and it is absorbed to a parent node), or carries out a split (a new state node is generated and divided).

For more detail, the state series correction unit 73 corrects state series data by merging when the number of nodes in a loop is one, and by splitting when the number of nodes in a loop is two or more.

### [Loop Correction Processing of the State Series Correction Unit 73]

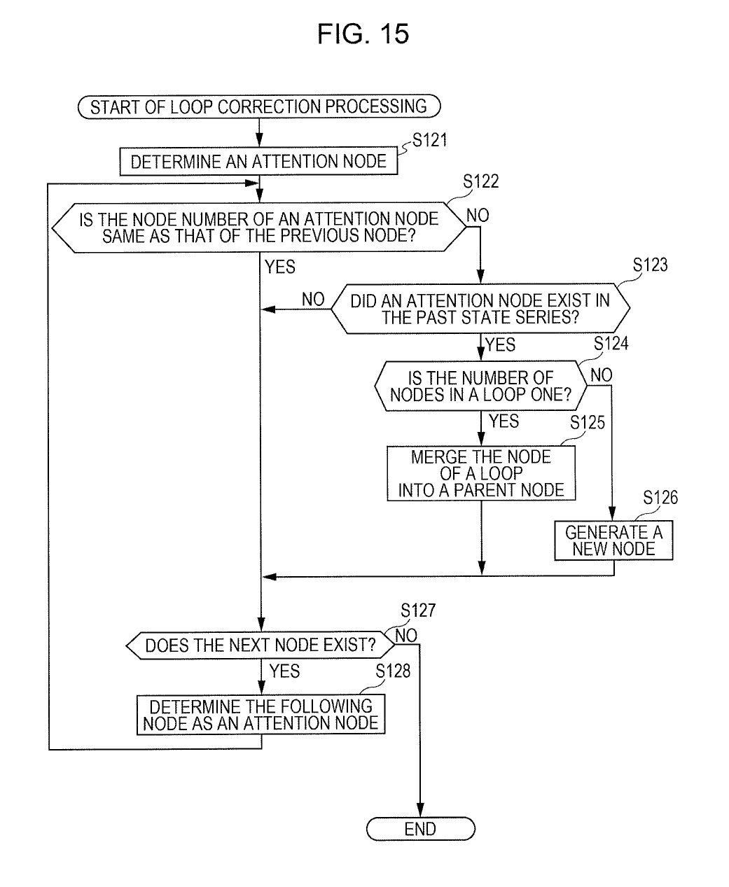

FIG. 15 shows a flow chart of the loop correction processing by the state series correction unit 73. The state series correction unit 73 has an internal memory which stores the state series data of the predetermined number of steps, this processing is started when the state series data of a certain number of steps is stored in an internal memory from the state series generation unit 72.

First, in step S121, the state series correction unit 73 determines an attention node with regard to the state series data supplied from the state series generation unit 72. That is, the state series correction unit 73 chooses the lead state node among the state series data supplied from the state series generation unit 72, and makes it an attention node.

In step S122, the state series correction unit 73 determines judges whether the node number of the attention node is the same as that of the previous node. When state transitions are self-transitions, the node number of the attention node becomes the same. Therefore, in other words, the state series correction unit 73 determines whether they are self-state transitions. In addition, when a lead state node is an attention node, it determines that the node number of an attention node is same with that of the previous node.

When at step S122 the state series correction unit 73 determines that the node number of an attention node is same as that of the previous node, processing proceeds to step S127 mentioned later.

On the other hand, when at step S122 the state series correction unit 73 determines that the node number of an attention node is not same as that of the previous node, processing proceeds to step S123, the state series correction unit 73 determines whether an attention node exists in the past state series. In step S123, it is determined that an attention node exists in the past state series when a loop exists in the state series data and there is a return to past state series by a looping process.

At step S123, when it is determined that an attention node does not exist in the past state series, processing proceeds to step S127 mentioned later.

On the other hand, at step S123, when it is determined that an attention node exists in the past state series, processing proceeds to step S124 and the state series correction unit 73 determines whether the number of nodes in a loop is one.

At step S124, when it is determined that the number of nodes in a loop is one, in step S125, the state series correction unit 73 merges the node of a loop into a parent node (node of a return place).

At the step S124, when it is determined that the number of nodes in a loop is two or more, in step S126, the state series correction unit 73 generates and divides a new node.

Whether there is a node after an attention node in state series data is determined in step S127 after processing of step S125 or step S126.

When at the step 127 it is determined that there is a node after an attention node, in step S128 the state series correction unit 73 determines the following node as an attention node, and processing is returned to step S122.

On the other hand, when it is determined that there is no node after an attention node at step S127, that is, when a loop is found in regard to all the state nodes of the state series data supplied from the state series generation unit 72, processing ends.

The state series correction unit 73 corrects the state series data supplied from the state series generation unit 72 by performing the above processing, and supplies the state series data after correction to the transition frequency counting unit 81, the state frequency counting unit 83, and the time series data classification unit 84.

In addition, for this embodiment of the present invention, it is determined whether the state series correction unit 73 corrected the loop by merging or splitting or whether the number of nodes in the loop was one. However, in the case where there is correction by merging or splitting, other criteria for determining such as whether the likelihood becomes high or the complexity of the learning model etc. can be used to determine whether there was correction by merging or splitting.

Moreover, when other information can be used, it is also possible to determine whether to correct by merging or splitting. For example, even if the number of the nodes in a loop is one, they may be important nodes such as a destination candidate's node, for example. In such a case, merging is not good and a splitting process will be used. Moreover, each may be an unimportant node even if there are 2 or more of nodes in a loop. Furthermore, alternatively, a case may be considered in that the total number of nodes may not be increased to be more because there are restrictions in the total number of nodes or the like. For this case, changes may be made according to the situation.

### [Description of Other Correction Processing by the State Series Correction Unit 73]

Next, an example of other correction processing of the state series data by the state series correction unit 73 is described.

FIG. 16 shows an example of the processing which corrects a share node with which one node is shared between two or more series.

In the state transition diagram of the upper part in FIG. 16, the node in the middle shown by attaching oblique lines is a share node. That is, each of the nodes before and after a share node is a separate node. As shown in the state transition diagram of the lower part of FIG. 16, the state series correction unit 73 splits (a new state node is generated and divided) the share node, and corrects the original state series data to two series.

When the likelihood of a node is low, although the place will be a separate node, it may lapse into a local minimum at the time of learning by an initial condition and shortage of the number of nodes of a model and the like, and may become such a share node. A case where the likelihood of a node is low at the node showing location data means the case where the distance between the location (center position) where the node shows and the location of actual data is large.

The share node generated by shortage of an initial condition and the number of nodes of a model etc. can be canceled by the processing which carries out the splitting of the share node perform as correction processing of state series data in the state series correction unit 73. In other words, the processing that could not be achieved on the restricted conditions (Ergodic HMM by sparse restrictions) by the model learning unit 71 can be realize ex-post facto (additionally) in the state series correction unit 73.

### [Share Node Correction Processing of the State Series Correction Unit 73]

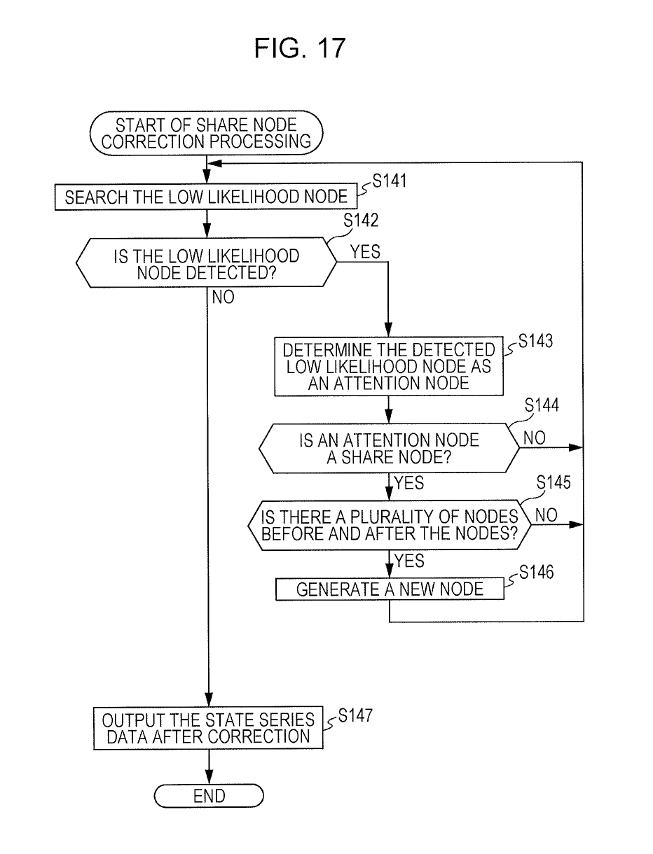

FIG. 17 shows the flow chart of the share node correction processing by the state series correction unit 73. From the state series generation unit 72, when all the state series data is stored in an internal memory, this processing is started.

First, in step S141 the state series correction unit 73 searches the low likelihood node which is a node that the likelihood is not more than a predetermined value in the state series data stored by the internal memory, and proceeds to step S142. In the embodiment of present invention, a node with a large distance between the center position of the node obtained by learning and the position of actual data becomes a low likelihood node.

In step S142, the state series correction unit 73 determines whether the low likelihood node was detected.

When it is determined that the low likelihood node has been detected at step S142, processing proceeds to step S143 and the state series correction unit 73 determines the detected low likelihood node as an attention node.

In step S144 the state series correction unit 73 determines whether an attention node is a share node. When it is determined that the attention node is not a share node at step S144, processing returns to step S141.

On the other hand, when it is determined that the attention node is a share node at step S144, processing proceeds to step S145, and the state series correction unit 73 determines whether there is a plurality of nodes before and after the node.

At step S145, when it is determined that there is not a plurality of nodes neither before nor after the node, processing returns to step S141. On the other hand, at step S145, when it is determined that there is a plurality of the nodes either before or after node, processing proceeds to step S146, and the state series correction unit 73 corrects the original state series data to two series by generating a new node. Also even after processing of step S146, processing returns to step S141.

Then, by repeating and performing processing from step S141 to step S146 mentioned above, all the low likelihood nodes sequentially detected, and the splitting of the share node is carried out.

When all the low likelihood nodes are detected, at step S142, it is determined that a low likelihood node has not been detected, and processing proceeds to step S147. Then, in step S147, the state series correction unit 73 outputs the state series data after correction by which correction was made to the original state series data, and ends processing. When no low likelihood nodes are detected, the original state series data is output as it is.

The state series correction unit 73 can perform the above share node correction processing, and can correct the state series data supplied from the state series generation unit 72.

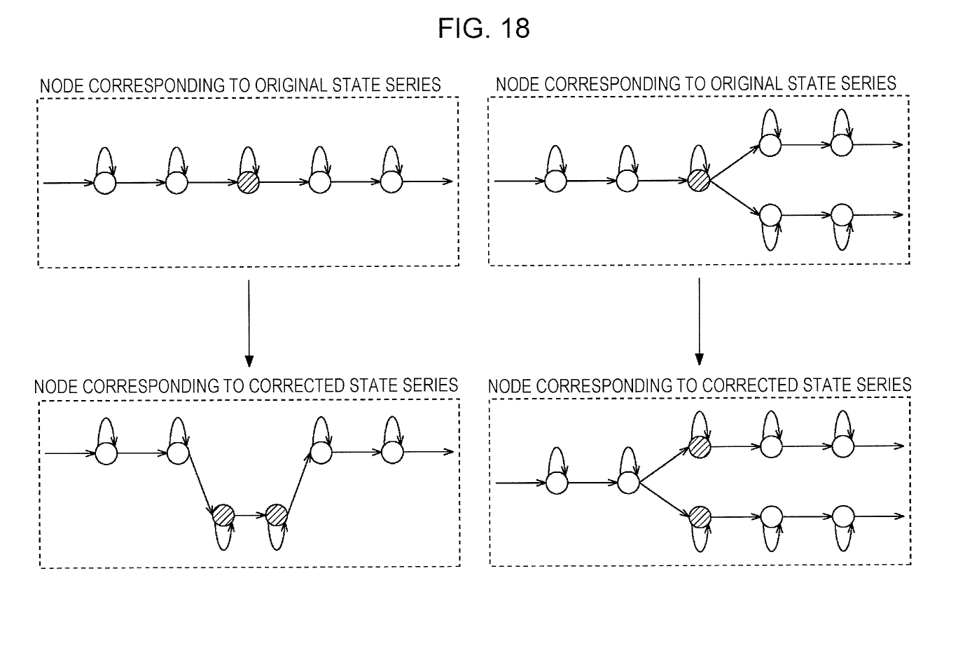

In addition, in the processing shown in FIGS. 16 and 17, only when there were two or more series in regard to both before and after directions, the splitting of the node is carried out. However, as shown in right-hand side of FIG. 18, even a case where there is a plurality of series either in the before or after directions, the splitting of the node is carried out.

Moreover, as shown in left-hand side of FIG. 18, even cases where there is not a plurality of series in either before or after directions, if the likelihood of a node becomes high for the case of having carried out the split, the splitting of the node is carried out. In any case, that the likelihood becomes higher than before correction due to a split is a condition. Moreover, in a split for the case where there is not a plurality of series in either before or after directions, as shown in left-hand side of FIG. 18, that self-transitions have occurred so that the number of steps may not change before and after correction also becomes a condition in the node for correction.

According to correction processing of the state series data by the above state series correction units 73, the correction is possible not only in the case newly adding a restraint to state series data but also in the case where it might be not possible to make a likelihood high enough due to lapse into a local minimum by learning.

In the processing shown in FIGS. 16 and 17, although the degree of a likelihood to learning data is checked, it may be made to check the degree of a likelihood by other data obtained simultaneously with learning data. It will usually learn as a multimodal model if there is something that influences the state transition in the learning model among other data series. However, the contribution of the data series is not large or it is perhaps irregular, learning only by data with a large contribution, and it can be avoided that the time series data with a little contribution gives more influence than necessity to the learning model by reflecting the influence only when correcting the state series data obtained according to the studied model in state series correction unit 73.

### [Verification of the Effect of the Action Learning Section 51]

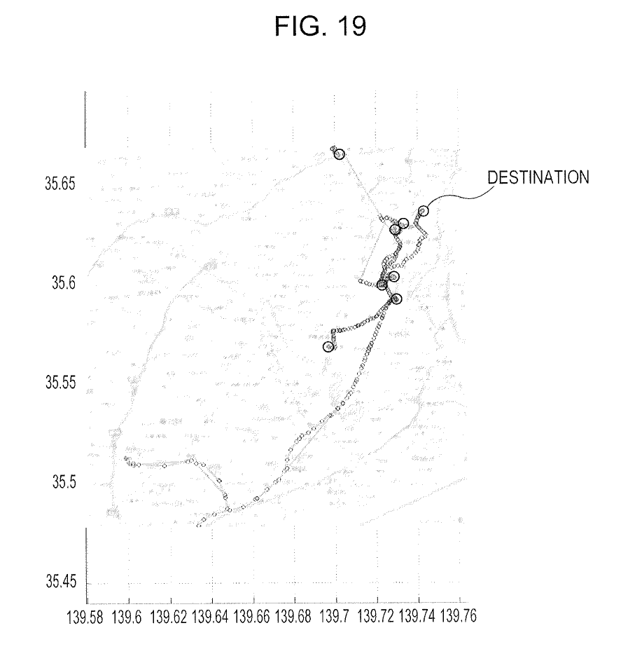

With references from FIG. 19 to FIG. 21, the effect of the action learning section 51 in comparison with the method of Japanese Patent Application No. 2009-208064 is described.

FIG. 19 shows the learning result when the action pattern of the user who has used the method of Japanese Patent Application No. 2009-208064 is learned. Therefore, a learning model is Ergodic HMM where sparse restrictions are given.

The small ellipse shown in FIG. 19 shows each state node obtained by learning. The number of state nodes could be 400 pieces. The ellipse is drawn so that it may become a size according to □ focusing on the observation parameter μ of a state node.

Moreover, although each state node is classified as a learning result whether each state node is a destination node (stationary node) or a movement node, due to restrictions in drawings, since the distinction of them is difficult to be expressed, the place with a destination node is added with the big circle in FIG. 19.

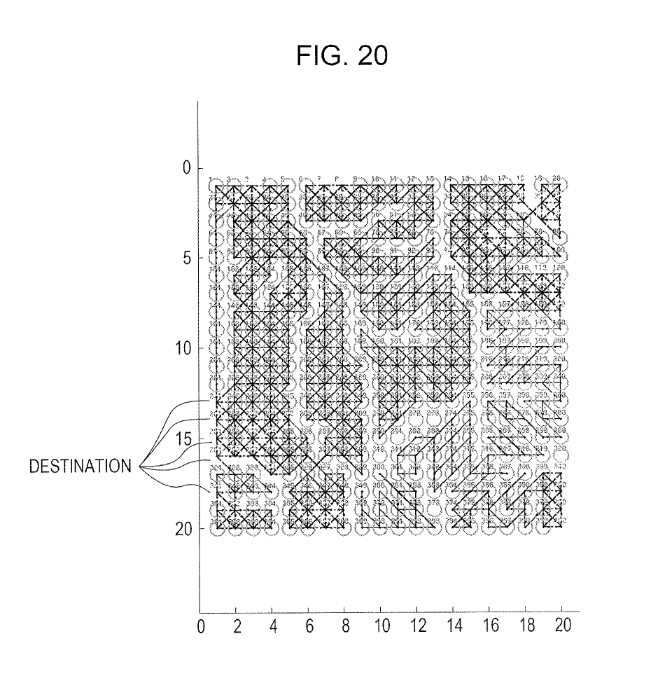

FIG. 20 is a rewritten figure in order to make more legible the transition relation between the state nodes in the learning model of FIG. 19. In FIG. 20, each node shown with the circle is arranged in the shape of a lattice, and only the transitions which are not 0 are connecting and expressing by the arrow. Therefore, it means that the transition probability is 0 between nodes without connection of an arrow. The depth of each node distinguishes whether or not it is the destination node, a destination node is shown by a pale gray circle and other nodes are shown by black circles. In addition, in FIG. 20, “destination” is attached in regard to a part of destination node.

Many state transitions between nodes exist in the learning result of FIG. 20. In other words, in the case in which Ergodic HMM where sparse restrictions are given is only made into a learning model, there is a plurality of transitions between nodes. By the method of Japanese Patent Application No. 2009-208064, since it searches for a plurality of courses considered by a plurality of transitions, it is expected that the processing becomes heavy because it takes time for searching for courses. However, in order to simplify this processing, since a part of the probability of the omitted course will no longer be reflected in destination arrival probability if processing which omits the course with a low probability is carried out on the turnoff in order to simplify this processing, arrival probability becomes low. Therefore, such processing is difficult to be performed.

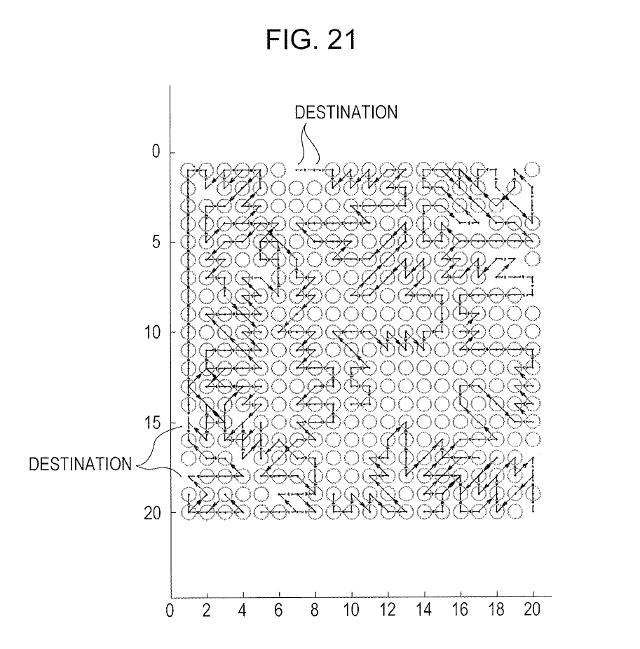

FIG. 21 shows the learning result by the action learning section 51. The method of illustration is the same as that of FIG. 20.

When FIG. 21 is referred to, it can be understood that the transitions whose transition probability between nodes is not 0 are significantly reduced. That is, it can be understood that the number of transitions between nodes is significantly reduced. Therefore, it is possible to further speed up processing of automatic search, course search, probability calculation, and time prediction, etc. of the destination.

Moreover, in the learning result by the action learning section 51, as shown in FIG. 21, since the number of branches is reduced, it is not necessary to carry out processing which omits the course with low probability, and the arrival probability to the destination does not necessarily become low. In addition, substantially, in the action learning section 51, although processing which omits the course where probability is low is performed, the phenomenon in which arrival probability to the destination becomes low, like the method of Japanese Patent Application No. 2009-208064, does not notably occur.

Moreover, in the learning result of FIG. 21, the destination nodes shown with pale gray circles are also significantly reduced. Therefore, in the action learning section 51, the number of destination nodes can also be greatly suppressed rather than the method of Japanese Patent Application No. 2009-208064.

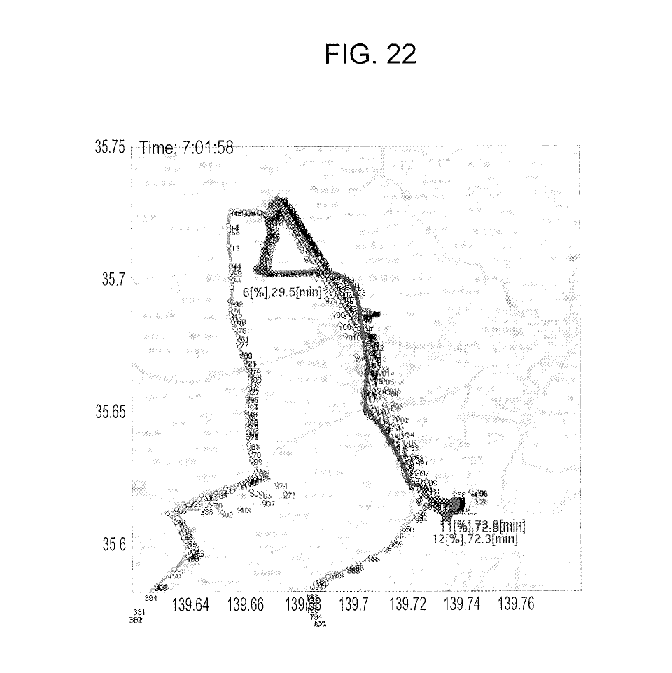

Next, with references from FIGS. 22 to 24, the state series correction unit 73 explains the effect at the time of correcting state series data by performing loop correction processing.

FIG. 22 shows the action pattern of a user different from the example of FIG. 19 and the learning result when model learning unit 71 studies is shown in FIG. 22. The learning model shown in FIG. 22 is a model where two or more branch courses are produced since the location data is missed by the day even though the location data that passed along the same course is used for the learned time series data. As a result, prediction processing has taken very long time.

In FIG. 22, the thick solid line drawn on the upper part of a node shows the prediction course which is a result of prediction processing.

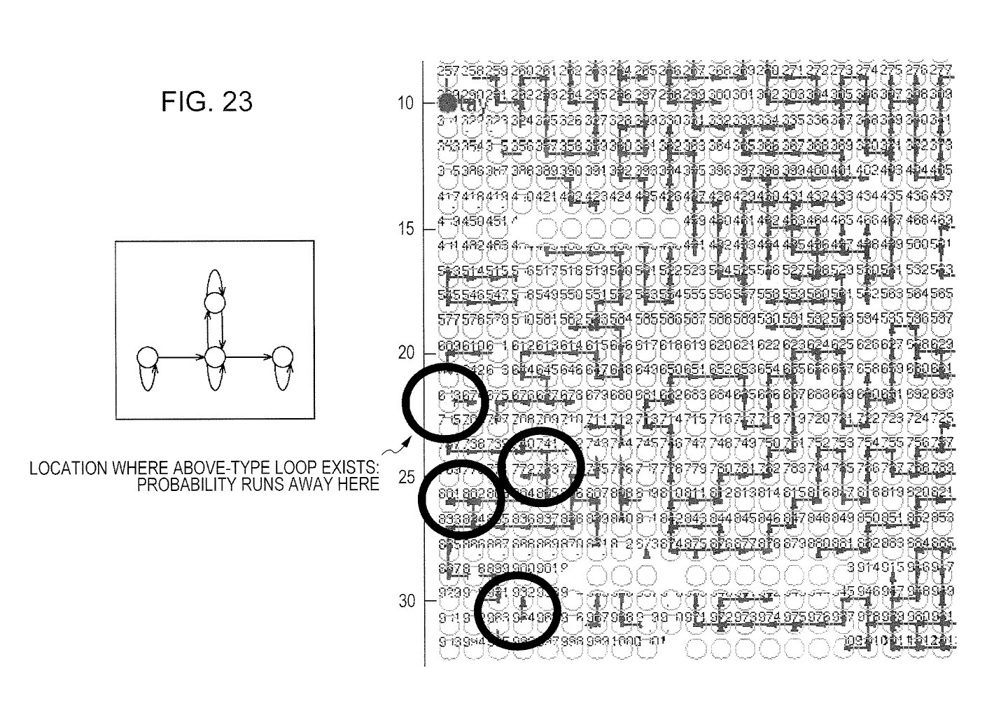

FIG. 23 is figure where the learning model and the prediction course in FIG. 22 are arranged like the lattice as shown in FIG. 20, and shows by enlarging a part of state node where the prediction course exists.

In FIG. 23, the thick gray solid line corresponds with a prediction course, i.e., the prediction course shown in FIG. 9.

As shown in FIG. 23, the course of the loop of the character of “T” as shown in FIG. 14 exists in the learning result of the model learning unit 71. FIG. 23 shows four places of a course of a loop like the character of “T” contained in a learning result and are surrounded by circle of the thick line. The searching for courses after this loop will double when there is one such loop.

The state series correction unit 73 described with references to FIGS. 14 and 15 corrects the original state series data so that it may become state series data of a left-to-right type.

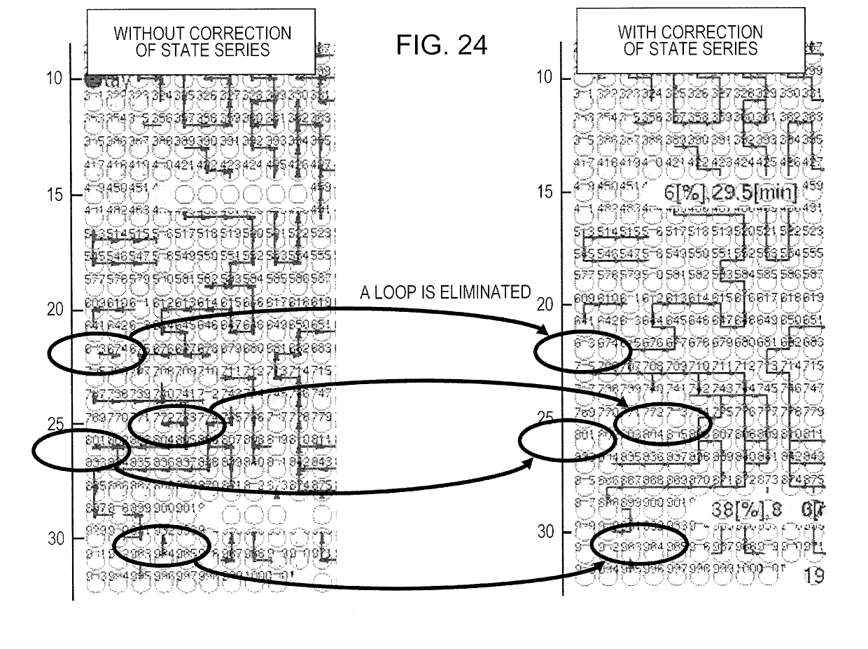

FIG. 24 shows before and after processing for loop correction processing. Four places surrounded by circle of the thick line in FIG. 23 are shown similarly.

By clearly referring to FIG. 24, the loop which existed by the original state series data has disappeared by the state series data after correction. Thus, a loop can be eliminated by loop correction processing of the state series correction unit 73.

In loop correction processing of FIGS. 14 and 15, it can be said that the learning model was corrected to Ergodic HMM which gave the restricted conditions of sparse restrictions so that restricted conditions of a left-to-right type might be given further. That is, the constraints that are not able to be realized on the restricted conditions of the sparse restrictions by the initial condition at the time of learning can be realized in the state series correction unit 73.

On the other hand, in share node correction processing of FIGS. 16 and 17, the node to which the degree of likelihood is decreasing can be chosen, and the correction which makes the degree of likelihood higher can be made. Even if this lapses into a local minimum at the time of learning, it becomes the measure which avoids it. Furthermore, other conditions which were not used for learning can also be taken in this correction processing.

A series of processing mentioned above can also be performed by hardware and by software. When performing a series of processing by software, the program which constitutes the software is installed in a computer. Here, the computer with the hardware of exclusive use built in and the general-purpose personal computer which can perform various kinds of functions by installing various kinds of programs are included as a computer.

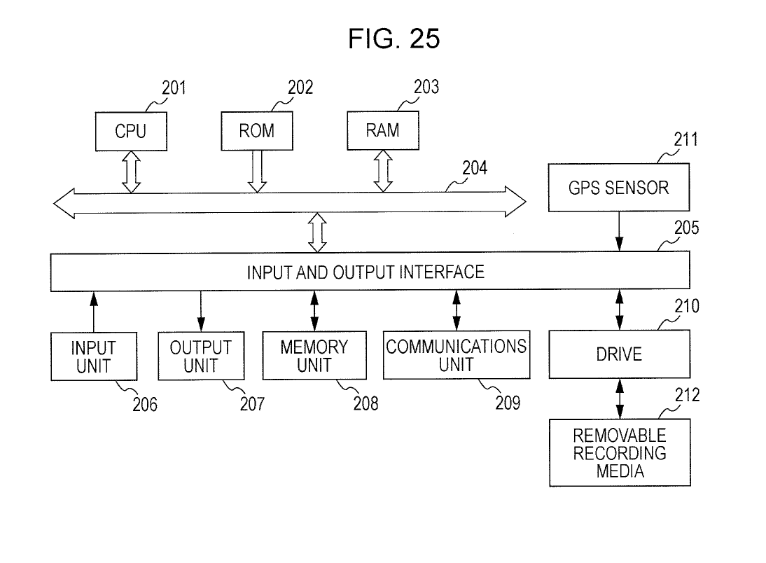

FIG. 25 is a block diagram showing the example of configuration of the hardware of a computer which performs a series of processing mentioned above by the program.

In the computer, CPU (Central Processing Unit) 201, ROM (Read Only Memory) 202, and RAM (Random Access Memory) 203 are mutually connected by bus 204.

The input-and-output interface 205 is further connected to the bus 204. The input unit 206, the output unit 207, the memory unit 208, the communications unit 209, the drive 210, and the GPS sensor 211 are connected to the input-and-output interface 205.

The input unit 206 includes a keyboard, a mouse and a microphone. The output unit 207 includes a display and a speaker. The memory unit 208 includes a hard disk and a non-volatile memory. The communications unit 209 includes a network interface. The drive 210 drives the removable recording media 212 such as a magnetic disk, an optical disc, a magneto-optical disc, or semiconductor memories. The GPS sensor 211 is equivalent to the GPS sensor 10 of FIG. 1.

In the computer constituted as mentioned above, a series of processing mentioned above are performed by which CPU 201 loads the program stored in the memory unit 208 to the RAM203 through the input-and-output interface 205 and bus 204, for example, and executes it.

The program which a computer (CPU201) executes can be stored on and provided form the removable recording medium 212 as package media etc., for example. Moreover, a program can be provided through the transmission media of cables or radio such as a local area network, the internet, and digital satellite broadcasting.

In computer, a program can be installed in the memory unit 208 through the input-and-output interface 205 by equipping the removable recording medium 212 in the drive 210. Moreover, a program can be received in the communications unit 209 through the transmission media of a cable or radio and can be installed in the memory unit 208. In addition, a program can be installed in ROM 202 or the memory unit 208 beforehand.

The program that the computer executes may be the program from which processing is done to the time series along the order of the explanation with this detailed statement, and may be the program to which processing is done according to necessary timing such as when it is called up or in parallel.

In addition, for this detailed statement, as well as when the step described in flow chart serially carried out in accordance with the indicated order, even if it is not of course necessarily processed serially, it may be performed according to necessary timing such as when it is called up or in parallel.

In addition, in this detailed statement, a system expresses the whole equipment constituted by two or more devices.

In the range which is not limited to the form of embodiment mentioned above and does not deviate from the summary of this invention, various modifications are possible for the form of implementation of this invention.

The present application contains subject matter related to that disclosed in Japanese Priority Patent Application JP 2009-276999 filed in the Japan Patent Office on Dec. 4, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A data processing apparatus comprising:
state series generation means that generates a time series data of state nodes from a time series data of a first event between time series data of the first event and a second event when a state transition model of the first event is expressed as a stochastic state transition model; and
computing means that computes the parameters for the stochastic state transition model of the first event and the second event by computing parameters of the time series data that corresponds to an appearance frequency of the state nodes, the appearance frequency of transitions among the state nodes, and the state nodes using the time series data of the first event and the time series data of the state nodes.

2. The data processing apparatus according to claim 1,
wherein the time series data of the first event is the time series data of location data for a user,
the time series data of the second event is the time series data of an action mode for the user,
the state series generation means generates the time series data of the state nodes when are expressed an action model showing the action state of the user from the time series data of the user's location data, as the stochastic state transition model, and
the computing means computes parameters of the stochastic state transition model by computing parameters of the time series data that corresponds to the appearance frequency of the state nodes, the appearance frequency of transitions among the state nodes, and the state nodes by using the time series data of the location data and the time series data of the state nodes.

3. The data processing apparatus according to claim 2,
wherein the state series generation means adopts the hidden Markov model as the stochastic state transition model and generates the time series data of the state nodes from the time series data of the user's location data by using parameters of the hidden Markov model sought by learning.

4. The data processing apparatus according to claim 3,
wherein the computing means has
count means which counts the frequency of each state and the frequency of each state transition on the time series data of the state nodes and
statistic computing means that computes the statistic of the time series data classified into each state node after that the time series data are separated into corresponding state nodes, and
the transition probability and the observation probability of the hidden Markov model are computed from the statistic of the time series data classified into the frequency of each state, the frequency of each state transition, and the state nodes.

5. The data processing apparatus according claim 4, further comprising:
the state series correction means that modifies the time series data of state nodes, the time series data of the state node being generated by the state series generation means.

6. The data processing apparatus according claim 5,
wherein the state series correction means modifies the time series data of state nodes so as to meet new restrictions for the state transition.

7. The data processing apparatus according claim 5,
wherein the state series correction means modifies the time series data of the state node so that the likelihood of state nodes is high.

8. The data processing apparatus according claim 5,
wherein the state series correction means further modifies by discriminating the time series data of the state node with other information.

9. A data processing method using a data processing apparatus that outputs parameters of a stochastic state transition model of a first event and a second event by including state series generation means and computing means, the method comprising:
causing the state series generation means of the data processing apparatus to generate the time series data of the state nodes when expressing the state transition model of the first event as the stochastic state transition model from the time series data of the second event between time series data of the first event and the second event; and
causing the computing means to compute parameter of the stochastic state transition model of the first event and second event by computing parameters of the time series data that corresponds to the appearance frequency of the state nodes, the appearance frequency of transitions among the state nodes, and the state nodes by using the time series data of the first event and the time series data of the state nodes.

10. A program causing a computer to function as means including:
state series generation means that generates the time series data of state nodes from the time series data of a first event between time series data of the first event and a second event when a state transition model of the first event is expressed as a stochastic state transition model; and
computing means that computes parameters of the stochastic state transition model of the first event and second event by computing parameters of the time series data that corresponds to an appearance frequency of the state nodes, the appearance frequency of transitions among the state nodes, and the state nodes by using the time series data of the first event and the time series data of the state nodes.

11. A data processing apparatus comprising:
a state series generation unit that generates a time series data of state nodes from a time series data of a first event between time series data of the first event and a second event when a state transition model of the first event is expressed as a stochastic state transition model; and
a computing unit that computes the parameters for the stochastic state transition model of the first event and the second event by computing parameters of the time series data that corresponds to an appearance frequency of the state nodes, the appearance frequency of transitions among the state nodes, and the state nodes using the time series data of the first event and the time series data of the state nodes.

12. A data processing method using a data processing apparatus that outputs parameters of a stochastic state transition model of a first event and a second event by including state series generation unit and computing unit, the method comprising:
causing the state series generation unit of the data processing apparatus to generate the time series data of the state nodes when expressing the state transition model of the first event as the stochastic state transition model from the time series data of the second event between time series data of the first event and the second event; and
causing the computing unit to compute parameter of the stochastic state transition model of the first event and second event by computing parameters of the time series data that corresponds to the appearance frequency of the state nodes, the appearance frequency of transitions among the state nodes, and the state nodes by using the time series data of the first event and the time series data of the state nodes.

13. A program causing a computer to function as unit including:
state series generation unit that generates the time series data of state nodes from the time series data of a first event between time series data of the first event and a second event when a state transition model of the first event is expressed as a stochastic state transition model; and
computing unit that computes parameters of the stochastic state transition model of the first event and second event by computing parameters of the time series data that corresponds to an appearance frequency of the state nodes, the appearance frequency of transitions among the state nodes, and the state nodes by using the time series data of the first event and the time series data of the state nodes.
